(19) United States
(12) Patent Application Publication
(10) Pub. No.: US 2016/0077646 A1
(43) Pub. Date: Mar. 17, 2016

(54) INFORMATION PROCESSING DEVICE AND INPUT CONTROL METHOD

(71) Applicant: FUJITSU LIMITED, Kawasaki-shi (JP)

(72) Inventor: Eiichi Matsuzaki, Koto (JP)

(73) Assignee: FUJITSU LIMITED, Kawasaki-shi (JP)

(21) Appl. No.: 14/947,221

(22) Filed: Nov. 20, 2015

Related U.S. Application Data
(63) Continuation of application No. PCT/JP2013/067830, filed on Jun. 28, 2013.

(51) Int. Cl. G06F 3/041

(52) U.S. Cl. CPC G06F 3/0412; G06F 3/0418; G06F 2203/04104

(57) ABSTRACT

An information processing device determines whether to update horizontal correction information, vertical correction information, both the horizontal correction information and the vertical correction information, or neither the horizontal correction information nor the vertical correction information, on the basis of a geometric relationship between a first object area, a second object area, a first contact area and a second contact area, the first and second object areas having been identified respectively in response to a first touch manipulation and a second touch manipulation and a first and a second contact areas respectively having been detected and having had positions corrected in response to the first touch manipulation and the second touch manipulation, when the first touch manipulation, a cancellation manipulation for cancelling the first touch manipulation, and the second touch manipulation were performed sequentially.

### CROSS-REFERENCE TO RELATED APPLICATION

This application is a continuation application of International Application PCT/JP2013/067830 filed on Jun. 28, 2013 and designated the U.S., the entire contents of which are incorporated herein by reference.

### FIELD

The embodiments discussed herein are related to an information processing device and an input control method.

### BACKGROUND

In recent years, devices provided with a touch screen have been used widely. Also, a variety of research has been conducted on inputting through a touch screen.

For example, an input device that enlarges a portion around a plurality of keys that have been pushed simultaneously or that enlarges the entire display window has been proposed. Also, an input device that automatically corrects a difference between the position contacted by the user on the touch panel and the proper button position on a software keyboard has been proposed. Further, a screen driving device has been proposed that has a configuration in which relative relationships between the manipulation unit image and the effective area can be corrected in a real time manner. In addition to these, a method that prevents an unintended operation in a case when the position touched by a finger is out of the effective area of the touch UI (User Interface) has been proposed.

Also, there is an information processing device that detects an instruction manipulation position on a display window of a display unit by using a touch panel. Then, the information processing device determines “whether the selection made on the selection item displayed in the instruction manipulation position is the right selection item that the user really wanted to select” on the basis of the manipulation states of the user after he or she has made the selection. When the selected item is not the right selection item, the information processing device stores the above instruction position as an incorrect instruction position. Then, the information processing device stores, as correction data, the difference between the position in which the right selection item is displayed and the display position that has been stored as an incorrect instruction position.

A technology of taking cancellation manipulations performed after some input manipulation into consideration has also been proposed.

For example, an image forming device operates as follows. Specifically, when the user pushes down the reset button within a prescribed period of time after performing input on the touch panel, the image forming device waits for input to be performed on the touch panel. When input has been performed, the image forming device determines “whether the input was performed on a button adjacent to the button that received the last input”. When the adjacent button is re-pressed, the image forming device deletes correction information that it has stored temporarily, and stores the correction information of the button that received the input after the reset button was pushed.

As described below, a technology for making it possible to execute autonomous calibration highly accurately and at an appropriate frequency in an information input device has also been proposed.

There may be a case where one of a plurality of first images is recognized on a first occasion and a second image is recognized on a second occasion that follows the first occasion. In this example, the plurality of first images may be images used for inputting information and the second image may be an image used for cancelling the input of the information.

In the above case, the information input device determines whether an image specified on a third occasion, following a second occasion, is adjacent to the image recognized on the first occasion in the manipulation image. When the determination is positive, the information input device records data representing the mutual positional relationship between the images recognized on the first and third occasions and data representing the accumulated number of times of positive determination. When the accumulated number of times has reached a prescribed value, the information input device sets, on the basis of the data representing the positional relationship, a correction value to be fed to an electric signal output from the position detection unit.

### [Patent Document 1] Japanese Laid-open Patent Publication No. 10-49305

### [Patent Document 2] Japanese Laid-open Patent Publication No. 2008-242958

### [Patent Document 3] Japanese Laid-open Patent Publication No. 2007-310739

### [Patent Document 4] Japanese Laid-open Patent Publication No. 2010-128508

### [Patent Document 5] Japanese Laid-open Patent Publication No. 2009-93368

### [Patent Document 6] Japanese Laid-open Patent Publication No. 2005-238793

### [Patent Document 7] Japanese Laid-open Patent Publication No. 2011-107864

### SUMMARY

According to an aspect of the embodiments, an information processing device includes a touch screen, a storage device and a processor. The processor that detects an area, touched in a touch manipulation, on the touch screen. The processor reads, from the storage device, horizontal correction information and vertical correction information for correcting a position of the detected area in a horizontal direction and a vertical direction, respectively. The processor corrects the position of the detected area by using the horizontal correction information and the vertical correction information. The processor identifies an area occupied by a graphical user interface object that is a target of the touch manipulation on the touch screen, on the basis of the corrected position. The processor determines whether to update the horizontal correction information, the vertical correction information, both the horizontal correction information and the vertical correction information, or neither the horizontal correction information nor the vertical correction information, on the basis of a geometric relationship between a first object area, a second object area, a first contact area and a second contact area, the first and second object areas having been identified respectively in response to a first touch manipulation and a second touch manipulation and the first and second contact areas respectively having been detected and having had positions corrected in response to the first touch manipulation and the second touch manipulation, when the first touch manipulation, a cancellation manipulation for cancelling the first touch manipulation, and the second touch manipulation were performed sequentially The processor operates in accordance with the determination.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block configuration view of a terminal device;

FIG. 2 illustrates two examples of changes caused by a first touch manipulation, a cancellation manipulation and a second manipulation;

FIG. 3 explains a relative relationship between the size of a GUI object and the size of an area in which the user's finger touches the touch screen;

FIG. 4 illustrates the hardware configuration of a computer;

FIG. 5 illustrates a plurality of examples of data formats of a correction DB;

FIG. 6 is a flowchart of a coordinate report process related to the detection of a touch manipulation and the correction of coordinates;

FIG. 7 is a flowchart for a monitoring process performed in relation to the management of a correction DB;

FIG. 8 is a flowchart for a correction DB update process;

FIG. 9 explains the coordinate system and also explains a plurality of examples related to the arrangement of two GUI objects; and

FIG. 10 explains angle θ, which represents the direction in which a second touch manipulation was performed relative to a first touch manipulation.

### DESCRIPTION OF EMBODIMENTS

In order to improve the usability of an information processing device provided with a touch screen, it is beneficial to correct the position of an area detected in response to a touch manipulation. However, when correction information to be used for correction is fixed or updated in an inappropriate manner, the usability is not improved so much. In some cases, there may even be a risk that the usability will deteriorate because the correction information is fixed or updated in an inappropriate manner. Technology of setting correction information appropriately has not been developed sufficiently, leaving room for improvement in usability.

Hereinafter, detailed explanations will be given for the embodiments by referring to the drawings.

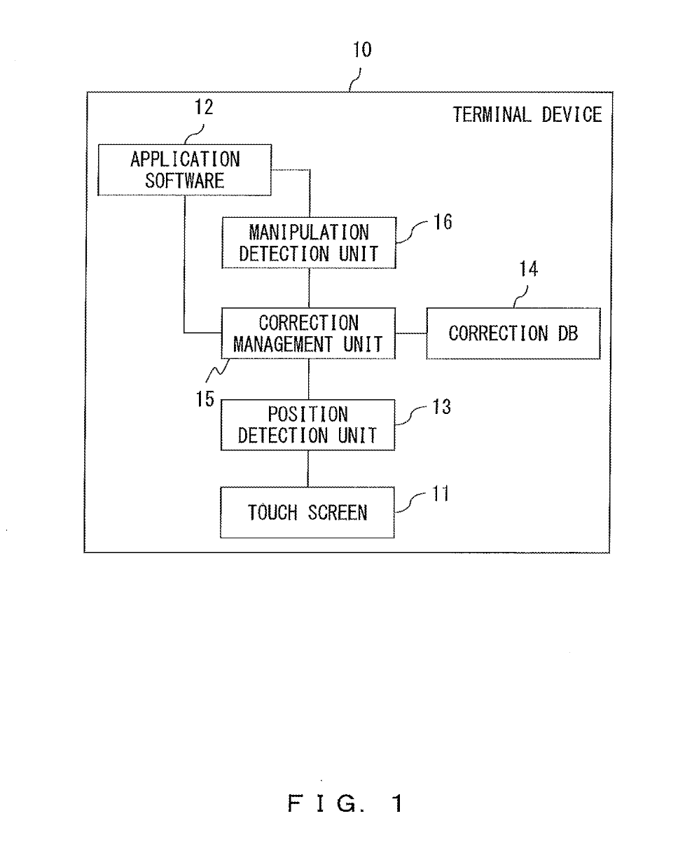

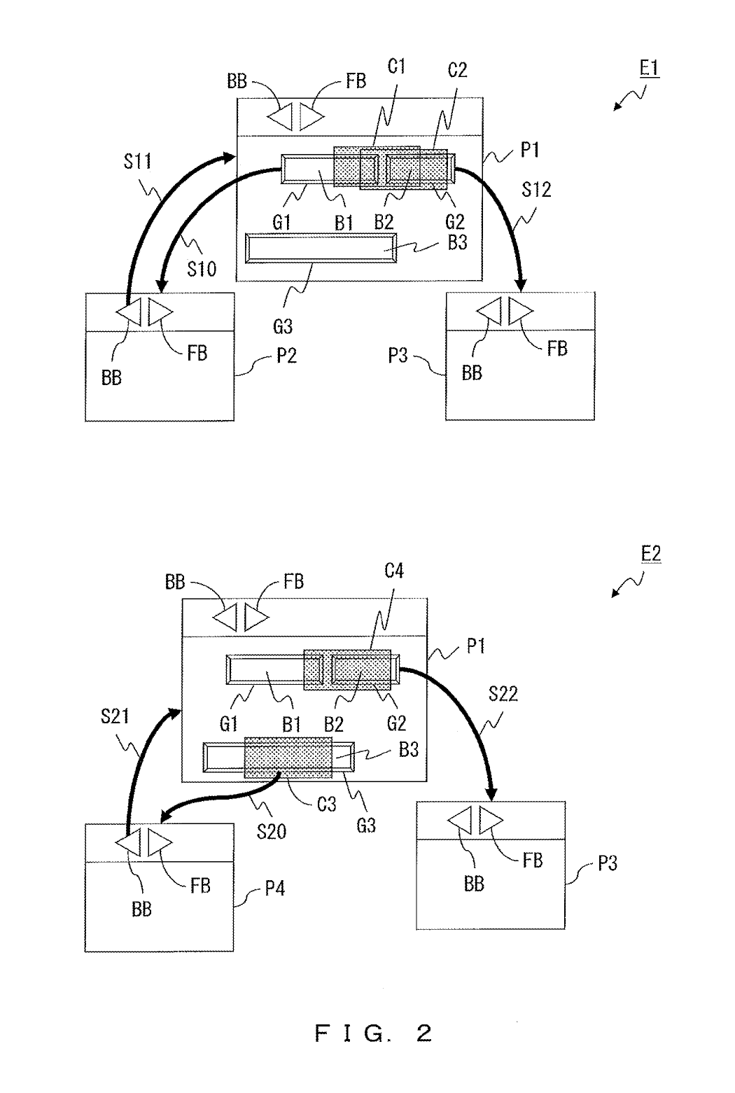

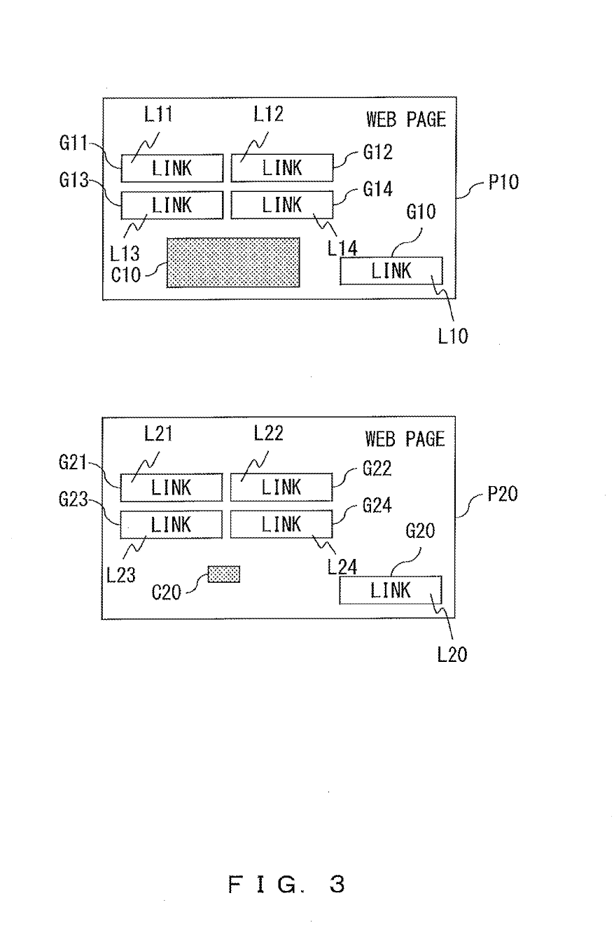

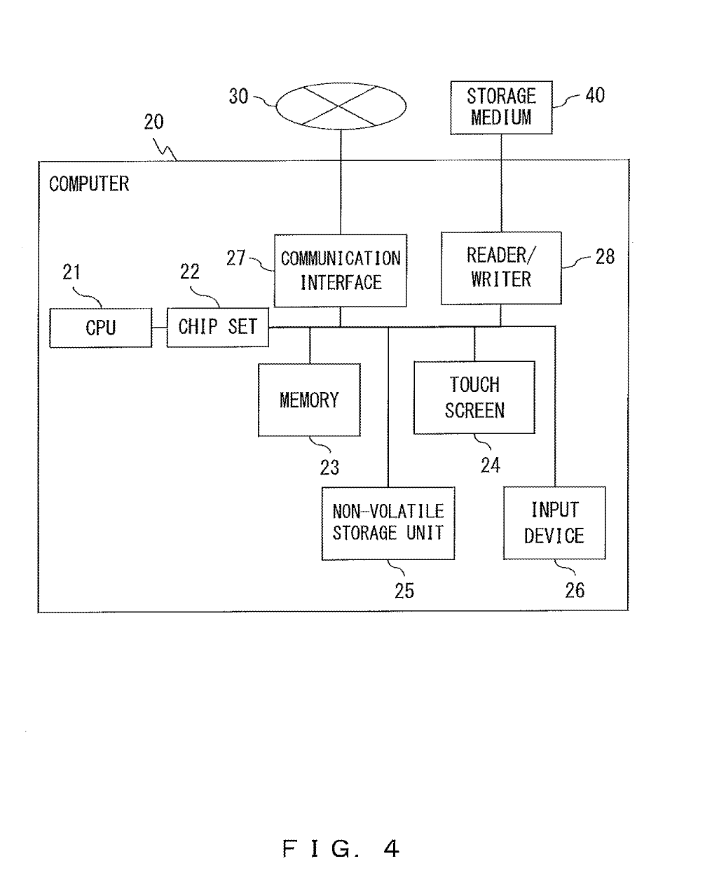

First, by referring to FIG. 1, the outline of a terminal device will be explained. Next, by referring to FIG. 2 and FIG. 3, an example of a series of touch manipulations and the size of an area touched in a touch manipulation will be explained. Thereafter, by referring to FIG. 4, an example of hardware that realizes a terminal device will be explained.

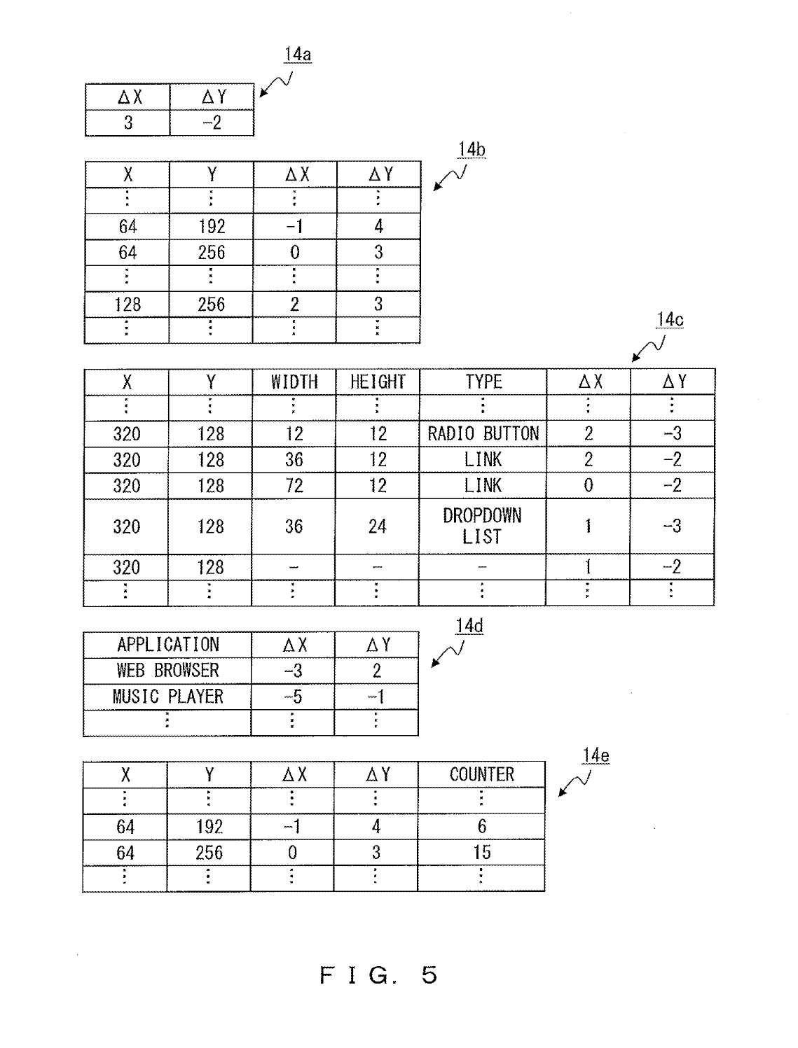

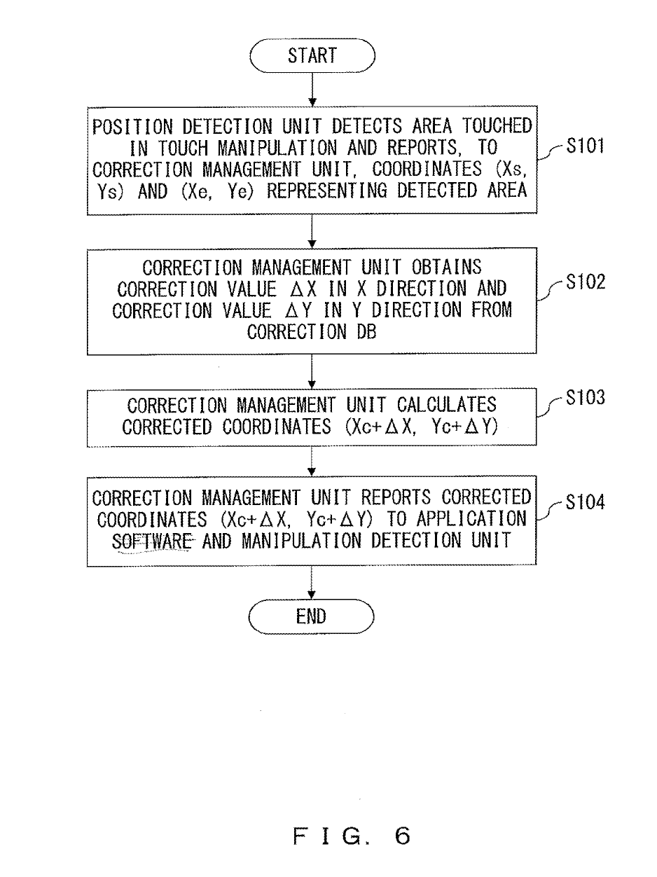

Thereafter, a specific example of data used for correction will be explained by referring to FIG. 5. Thereafter, operations of a terminal device will be explained in detail by referring to FIG. 6 through FIG. 10. After all of these explanations, other embodiments and the effects of the respective embodiments will be explained.

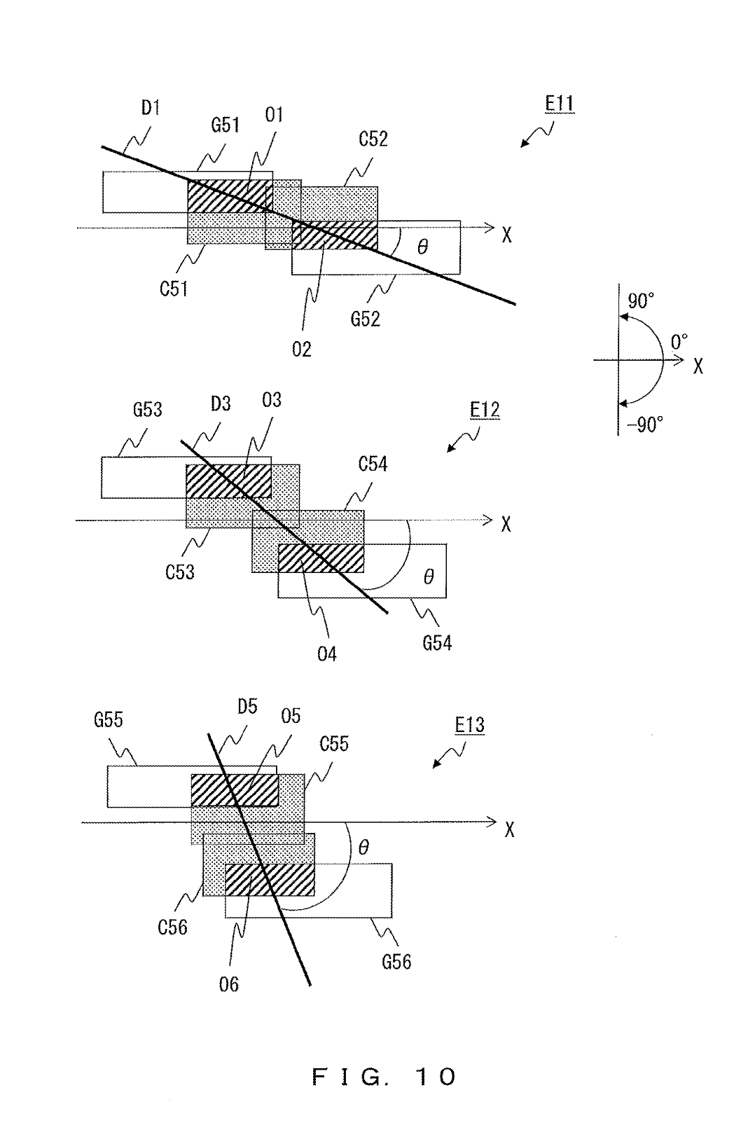

FIG. 1 is a block configuration view of a terminal device. A terminal device 10 illustrated in FIG. 10 includes a touch screen 11 for executing at least one piece of application software 12. Also, the terminal device 10 includes a position detection unit 13, a correction DB (database) 14, a correction management unit 15 and a manipulation detection unit 16.

The terminal device 10 may be a type of an information processing device. Specifically, the terminal device 10 may be an arbitrary one of various devices such as a desktop PC (Personal Computer), a laptop PC, a tablet PC, a smartphone, a media player, a portable game device, a mobile phone, etc. The terminal device 10 may be a computer 20 illustrated in FIG. 20, which will be described later.

The touch screen 11 may be a device that is a result of combining a display device, which is an output device, and a touch panel, which is an input device (specifically, a pointing device). It is preferable that appropriate alignment be conducted between the position on the display device and the position pointed at by the pointing device.

However, even when the alignment has been insufficient, the difference between the position on the display device and the position pointed at by the pointing device is compensated for through correction that uses horizontal correction information and vertical correction information, which will be described later. From a certain point of view, correction using horizontal correction information and vertical correction information compensates for not only a user's tendencies in inputting, but also the positional difference between the display device, which is an output device, and a touch panel, which is an input device.

Accordingly, for the sake of convenience in the explanations below, a position on a display device and a position pointed at by a pointing device are not treated separately and they may be referred to as “position”, “position on the touch screen 11”, etc.

The types of the application software 12 are not limited particularly. The terminal device 10 may execute a plurality of pieces of the application software 12. The application software 12 may be an application program.

The position detection unit 13 detects an area, on the touch screen 11, touched in a touch manipulation. For example, when the user has touched the touch screen 11 with a finger, the position detection unit 13 detects the area touched by the finger. Examples of touch manipulations may include a single tap manipulation. Other examples of touch manipulations may include a long tap manipulation, a double tap manipulation, a flicking manipulation, etc.

Specifically, the position detection unit 13 may detect the position and the size of an area touched in a touch manipulation. For example, the position detection unit 13 may treat the shape of the area touched in a touch manipulation as a prescribed shape in an approximate manner.

Examples of prescribed shapes may include a circle, an ellipse, a rectangle, etc. For example, when a prescribed shape is a rectangle, the position detection unit 13 may detect the bounding box of the area actually touched in a touch manipulation as an “area touched in touch manipulation”.

The bounding box of an area is the smallest rectangle that includes the area and that is enclosed by sides extending in the horizontal directions and sides extending in the vertical directions. Note that the horizontal directions and the vertical directions are horizontal and vertical directions on the plane of the touch screen 11 unless otherwise noted.

The position detection unit 13 may further detect the shape of an area in addition to the position and the size of the area.

It is also possible for the position detection unit 13 to detect only the position of an area. In such a case, the position detection unit 13 may recognize that, approximately, “the size of an area whose position has been detected is a prescribed size”. The prescribed size is determined by at least one value that has been stored in advance.

The at least one value above may be for example at least one constant representing the average size of a finger. The at least one value above may be for example one value representing the diameter of a circle, one value representing the length of one side of a square, or two values representing the width and the height of a square.

Alternatively, the user of the terminal device 10 may in advance perform a special touch manipulation for registering the at least one value above that is unique to the user in the terminal device 10. In such a case, the position detection unit 13 detects the size of the area, on the touch screen 11, touched in the special touch manipulation, and stores in a storage device at least one value representing the detected size. The position detection unit 13 may thereafter omit processes of detecting the size of the area actually touched in each touch manipulation. In other words, the position detection unit 13 may use the stored at least one value above instead of actually detecting the size of the area for each touch manipulation.

Regardless of whether the size of the actual area is detected or the area is treated as one having a prescribed size in an approximate manner, the position detection unit 13 can output to the correction management unit 15 the position and the size of the area touched in the touch manipulation. The position detection unit 13 is an example of a detection unit for detecting an area, on the touch screen 11, touched in a touch manipulation.

The correction DB 14 stores the horizontal correction information and the vertical correction information. The horizontal correction information and the vertical correction information are information for correcting the position of an area detected by the position detection unit 13 in the horizontal directions and the vertical directions, respectively. Correction of the position of an area is, in other words, adjustment of the position, and is also calibration of the position.

One value may be used as horizontal correction information, and horizontal correction information may contain a plurality of values corresponding to a plurality of conditions.

Similarly, one value may be used as vertical correction information, and vertical correction information may contain a plurality of values corresponding to a plurality of conditions. In any of these cases, the correction DB 14 is an example of a storage unit that stores the horizontal correction information and the vertical correction information. Detailed explanations will be given for the horizontal correction information and the vertical correction information by referring to FIG. 5.

The correction management unit 15 corrects the position of an area detected by the position detection unit 13 by using the horizontal correction information and the vertical correction information. In other words, the correction management unit 15 reads the horizontal correction information and the vertical correction information from the correction DB 14, and corrects the position of an area by using the horizontal correction information and the vertical correction information. Then, the correction management unit 15 reports the corrected position to the application software 12 and the manipulation detection unit 16. The correction management unit 15 may also report the size of an area to both the application software 12 and the manipulation detection unit 16 or to one of them.

Alternatively, the correction management unit 15 may report the corrected position only to the application software 12 directly. In such a case, the manipulation detection unit 16 may hook the report from the correction management unit 15 to the application software 12 so as to obtain information of the corrected position. Similarly, the manipulation detection unit 16 may hook the report from the correction management unit 15 to the application software 12 so as to obtain information representing the size of an area.

As described above, the correction management unit 15 is an example of a correction unit that corrects the position of a detected area. In the explanations below, an area that was detected by the position detection unit 13 and had its position corrected by the correction management unit 15 is referred to also as a “contact area” for the sake of convenience of explanation. A contact area is an area treated as an area “touched in a touch manipulation”.

The manipulation detection unit 16 identifies the area, on the touch screen 11, occupied by the GUI (Graphical User Interface) object that is the target of the touch manipulation, on the basis of the corrected position (i.e., the position of the contact area). In the explanations below, an area occupied by a GUI object on the touch screen 11 is also referred to as an “object area” for the sake of convenience.

Note that it is also possible to identify, as an object area, a bounding box in an area that is actually occupied by the GUI object that is the target of a touch manipulation on the touch screen 11. When the GUI object that is the target of a touch manipulation is not rectangular, the processing loads are reduced by identifying the bounding box as an object area.

A GUI object is also referred to as “GUI component”, “GUI widget”, “widget”, “GUI control”, “control”, etc. Examples of GUI objects may include link text (i.e., a character string in which a hyperlink is embedded), a button (for example, an image in which a hyperlink is embedded), a radio button, a check box, a slider, a dropdown list, a tab, a menu, etc.

For example, when a contact area is located in an area occupied by a button on the touch screen 11, the manipulation detection unit 16 may identify that button as the target of a touch manipulation. In other words, the manipulation detection unit 16 may identify the object area occupied by that button on the touch screen 11. The manipulation detection unit reports the identified object area to the correction management unit 15.

Note that each GUI object used by the application software 12 is rendered by the application software 12 on the touch screen 11 via an appropriate API (Application Programming Interface). The manipulation detection unit 16 may be implemented by for example using an existing API for obtaining a layout of a GUI object. The manipulation detection unit 16 can recognize the position and size of each GUI object via an

API. For example, the position of each GUI object may be represented by the position of a point (for example, the center point or the point at the upper left corner) that represents each GUI object.

For example, the manipulation detection unit 16 may recognize the position of each of at least one GUI object via an API. The manipulation detection unit 16 may also search for the GUI object closest to the position reported by the correction management unit 15 (i.e., the GUI object closest to the contact area) on the basis of each recognized position. The manipulation detection unit 16 may identify the GUI object closest to the contact area as the target of a touch manipulation when the distance from the contact area to the GUI object closest to the contact area is equal to or shorter than a threshold.

As described above, the manipulation detection unit 16 is an example of an identifying unit that identifies the area occupied by a GUI object that is the target of a touch manipulation on the touch screen 11.

Further, the manipulation detection unit 16 detects a manipulation in the application software 12 in response to a touch manipulation by monitoring the application software 12. When the terminal device 10 also includes an input device (for example, a hardware button, a keyboard, etc.) that is not the touch screen 11, the manipulation detection unit 16 also detects a manipulation in the application software 12 in response to input from the input device.

It is assumed for example that the application software 12 is a web browser and the user has tapped a link text in a web page. In such a case, the position detection unit 13 detects the area touched by the finger in response to the touch manipulation (i.e., a tap manipulation), and the correction management unit 15 corrects the position of the area. Then, the application software 12 recognizes that “link text was tapped” on the basis of the corrected position, and executes a jump to the web page specified by the hyperlink embedded in the link text.

Accordingly, in this case, “manipulation in the application software 12 in response to touch manipulation” is specifically a jump to a different web page from the web page being displayed currently on the touch screen 11. Accordingly, in this case, the manipulation detection unit 16 detects the manipulation of “jump” by monitoring the application software 12.

It is also assumed that the user thereafter tapped the “Back” button on the web browser. In such a case too, the position detection unit 13 detects the area touched by the finger in response to the touch manipulation, and the correction management unit 15 corrects the position of the area. As a result of this, the application software 12 recognizes the tapping on the “Back” button, and executes a process of returning to the previous web page.

Therefore, in this case, “manipulation in the application software 12 in response to touch manipulation” is specifically a process of returning to the previous web page from the web page being displayed currently on the touch screen 11. In other words, the manipulation in the application software 12 in this case is a cancellation manipulation for cancelling the previous manipulation. A cancellation manipulation is in other words an undo manipulation.

Also, when the terminal device 10 has a keyboard, some prescribed keyboard shortcuts may be set. For example, the web browser may be set so that when a prescribed key is pushed, a manipulation of returning from the web page that is being displayed currently on the touch screen 11 to the previous web page is performed. The manipulation detection unit 16 also detects manipulations in the application software 12 in response to this kind of pushing of a prescribed key.

As another example, there may be a case where the application software 12 has a layered menu. In such a case, when a touch manipulation is performed on a prescribed GUI object so as to return to a layer higher than the current layer, the manipulation detection unit 16 may detect that “cancellation manipulation has been performed”.

As a matter of course, when a touch manipulation has been performed on an ineffective area (i.e., an area in which no GUI object for causing the application software 12 to execute a process is arranged), the application software 12 does not execute a process. In other words, when the corrected position reported from the correction management unit 15 is in an ineffective area, the application software 12 does not execute a process. In such a case, the manipulation detection unit 16 does not detect a manipulation in the application software 12, either.

Detecting a manipulation in the application software 12, the manipulation detection unit 16 reports the detection of the manipulation to the correction management unit 15. This report is used for managing updates of the correction DB 14.

Specifically, the correction management unit 15 manages updates of the correction DB 14 in addition to correcting positions as described above. For the management, the correction management unit 15 uses reports from the manipulation detection unit 16.

More specifically, the correction management unit 15 determines “whether the first touch manipulation, the manipulation for cancelling the first touch manipulation, and the second touch manipulation were performed sequentially” on the basis of a report from the manipulation detection unit 16. In other words, the correction management unit 15 monitors whether a specific manipulation sequence of “the first touch manipulation, the cancellation manipulation for cancelling the first touch manipulation, and the second touch manipulation” was executed. Note that for the sake of convenience of explanation, a manipulation performed by the user in order to cancel a touch manipulation and a manipulation performed by the application software 12 in order to cancel the previous manipulation in response to the cancellation manipulation performed by the user are both referred to as “cancellation manipulation”.

When the first touch manipulation, a manipulation for cancelling the first touch manipulation, and the second touch manipulation were conducted sequentially, the correction management unit 15 determines whether to update the horizontal correction information, to update the vertical correction information, to update both of them, or to update neither of them. More specifically, when a cancellation manipulation for cancelling the second touch manipulation has not been performed within a prescribed period of time after the second touch manipulation, the correction management unit 15 determines which of the following four policies to employ. Then, the correction management unit 15 operates in accordance with the determined policy.
Policy that horizontal correction information is updated and vertical correction information is not updated
Policy that vertical correction information is updated and horizontal correction information is not updated
Policy that both horizontal correction information and vertical correction information are updated
Policy that neither horizontal correction information nor vertical correction information is updated

Specifically, the correction management unit 15 determines which of the above four policies to employ in accordance with the geometric relationships between the following four areas.
Object area identified by the manipulation detection unit 16 in response to the first touch manipulation, which is also referred to as “first object area”
Object area identified by the manipulation detection unit 16 in response to the second touch manipulation, which is also referred to as “second object area”
Contact area that was detected by the position detection unit 13 and had its position corrected by the correction management unit 15 in response to the first touch manipulation, which is also referred to as “first contact area”
Contact area that was detected by the position detection unit 13 and had its position corrected by the correction management unit 15 in response to the second touch manipulation, which is also referred to as “second contact area”

Note that geometric relationships between at least two areas may include for example the following various relationships.

Positional relationship between areas (for example, relationships related to the distance between two areas, the distance between the points representing two areas, the direction in which an area exists with respect to another area, etc.)
Relationship related to sizes between areas (for example, width, height or both)
Relationship related to overlapping between areas (for example, relationships related to whether two areas are overlapping at least partially, how much the two areas are overlapping, etc.)

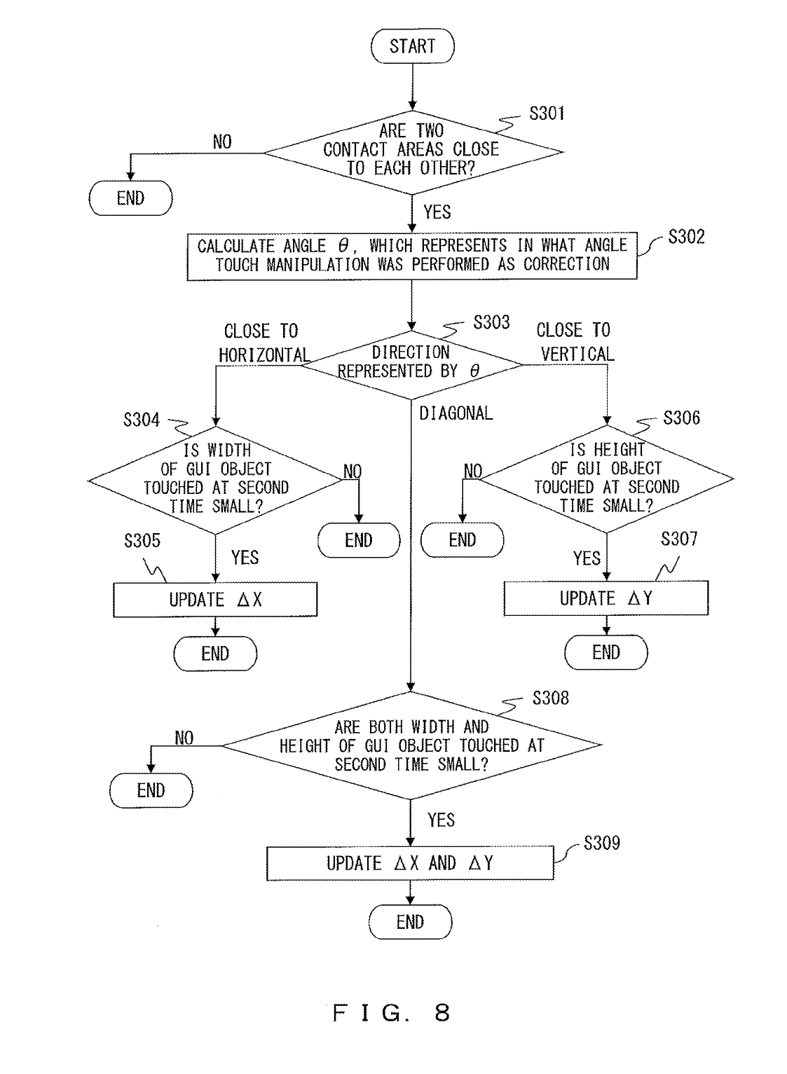

How the correction management unit 15 makes a determination on the basis of what geometric relationship specifically will be explained later in detail by referring to FIG. 8 through FIG. 10. Note that examples of the above geometric relationships between areas may include indirect relationships related to derivative areas defined by the position and/or the size of the original areas, in addition to direct relationships between the above four areas. For example, the positional relationship between a first overlapping area, in which two of the four areas are overlapping, and a second overlapping area, in which the remaining two areas are overlapping, is also an example of geometric relationships between the four areas.

Incidentally, the correction management unit 15 is an example of the correction unit as described above. Further, the correction management unit 15 is an example of an updating unit that determines whether to update the horizontal correction information, the vertical correction information, both of them, or neither of them in accordance with the geometric relationship between the above four areas so as to operate in accordance with the determination.

FIG. 2 illustrates two examples of changes caused by a first touch manipulation, a cancellation manipulation, and a second manipulation. Examples E1 and E2 illustrated in FIG. 2 both illustrate cases when the application software 12 is a web browser.

In example E1, a window of the application software 12 is displayed on the touch screen 11, and the window is displaying web page P1 and a tool bar. The tool bar includes “Back” button BB and “Forward” button FB.

Three GUI objects (specifically, three buttons B1 through B3) are displayed on web page P1. Buttons B1 through B3 occupy object areas G1 through G3 respectively on the touch screen 11.

Also, for the sake of convenience of explanation below, it is assumed that contact areas and object areas are both rectangular. For example, the position detection unit 13 may detect a bounding box in an area actually touched in a touch manipulation. Also, the manipulation detection unit 16 may detect a bounding box in an area actually occupied by a GUI object that is the target of a touch manipulation.

When the user has performed a first touch manipulation, the area touched in the first touch manipulation is detected by the position detection unit 13 and the position of the detected area is corrected by the correction management unit 15. The area that had its position thus corrected is contact area C1. Contact area C1 is overlapping both object area G1 and object area G2; however, the area in which contact area C1 and object area G1 are overlapping is larger than the area in which contact area C1 and object area G2 are overlapping. From a different point of view, contact area C1 is closer to object area G1 than to object area G2.

The correction management unit 15 reports the position of contact area C1 to the application software 12. In example E1, the application software 12 identifies button B1 as the GUI object that is the target of the first touch manipulation on the basis of the position reported by the correction management unit 15.

As a result of this, as represented by step S10, the application software 12 executes the manipulation associated with button B1. Specifically, in step S10, the application software 12 reads web page P2 specified by the hyperlink embedded in button B1 so as to display web page P2 in the window.

Meanwhile, the manipulation detection unit 16 also recognizes the position of contact area C1. As described above, the correction management unit 15 may report the position of contact area C1 directly to the manipulation detection unit 16, and the manipulation detection unit 16 may hook the report from the correction management unit 15 to the application software 12.

In any of these cases, the manipulation detection unit 16 identifies the object area occupied by the GUI object that is the target of the first touch manipulation on the basis of the position of contact area C1 (i.e., the position reported from the correction management unit 15 to the application software 12). In other words, the manipulation detection unit 16 identifies object area G1. The manipulation detection unit 16 may use for example an existing API so as to recognize that button B1 has been arranged in the position of contact area C1 (or that the GUI object closest to contact area C1 is button B1). Also, the manipulation detection unit 16 may recognize object area G1 occupied by button B1 via the API.

Further, the manipulation detection unit 16 monitors the application software 12. Accordingly, when a jump from web page P1 to web page P2 has been executed by the application software 12 in step S10 as described above, the manipulation detection unit 16 detects the jump. The jump thus detected is in other words a manipulation associated with identified object area G1, which is one of the manipulations in the application software 12.

Detecting a jump, the manipulation detection unit 16 reports the detection of the jump. Specifically, the manipulation detection unit 16 reports to the correction management unit 15 the fact that “in response to the first touch manipulation, manipulation of jumping from web page P1 to web page P2 has been executed in the application software 12”. In making this report, the manipulation detection unit 16 also reports to the correction management unit 15 the position and the size of identified object area G1.

Incidentally, when the user originally intended to tap button B2 instead of button B1, seeing web page P2, the user notices that the intended manipulation has not been executed. Accordingly, the user performs a cancellation manipulation for cancelling the first touch manipulation. Specifically, the user taps “Back” button BB.

Also for the tap manipulation on “Back” button BB, the position is detected and corrected by the position detection unit 13 and the correction management unit 15, respectively. Then, the correction management unit 15 reports the position of the contact area to the application software 12 so that the application software 12 recognizes that the “Back” button BB was tapped. As a result of this, the application software 12 executes the process of returning to web page P1 from web page P2 in step S11, and web page P1 is displayed again in the window.

Meanwhile, because the manipulation detection unit 16 continues to monitor the application software 12, the manipulation detection unit 16 also detects a manipulation in the application software 12 in step S11. Specifically, the manipulation detection unit 16 detects that the process of cancelling the jump detected in step S10 has been executed in the application software 12.

The manipulation detection unit 16 reports the detection result to the correction management unit 15. Specifically, the manipulation detection unit 16 reports to the correction management unit 15 the fact that “in response to a cancellation manipulation performed by the user, a manipulation of returning from web page P2 to web page P1 has been executed in the application software 12”.

The user performs the second touch manipulation on web page P1, which has been displayed again. Specifically in example E1, the user performs the second touch manipulation, intending to tap button B2.

The area touched in the second touch manipulation is detected by the position detection unit 13 and the position of the detected area is corrected by the correction management unit 15. The area that had its position thus corrected is contact area C2.

The correction management unit 15 reports the position of contact area C2 to the application software 12. As illustrated in FIG. 2, contact area C2 is closer to object area G2 than to object area G1. Accordingly, the application software 12 identifies button B2 as the GUI object that is the target of the second touch manipulation.

As a result of this, as represented by step S12, the application software 12 executes the manipulation associated with button B2. Specifically, in step S12, the application software 12 reads web page P3 specified by the hyperlink embedded in button B2 so as to display web page P2 in the window.

Meanwhile, the manipulation detection unit 16 also recognizes the position of contact area C2. Then, the manipulation detection unit 16 identifies object area G2 as the object area occupied by the GUI object that is the target of the second touch manipulation on the basis of the position of contact area C2.

Also, because the manipulation detection unit 16 monitors the application software 12, the manipulation detection unit 16 detects a jump from web page P1 to web page P3 conducted in step S12. Detecting the jump, the manipulation detection unit 16 reports the detection of the jump to the correction management unit 15. Specifically, the manipulation detection unit 16 reports to the correction management unit 15 the fact that “in response to a second touch manipulation, a manipulation of jumping from web page P1 to web page P3 has been executed in the application software 12”. In making this report, the manipulation detection unit 16 also reports to the correction management unit 15 the position and the size of identified object area G2.

On the basis of the reports from the manipulation detection unit 16 in steps S10, S11 and S12 described above, the correction management unit 15 detects that a series of “a first touch manipulation, a cancellation manipulation for cancelling the first touch manipulation, and a second touch manipulation” was performed sequentially. In response to the detection, the correction management unit 15 determines whether to update the horizontal correction information and whether to update the vertical correction information.

Specifically, the correction management unit 15 makes the determination in accordance with the geometric relationships between object area G1, object area G2, contact area C1 and contact area C2. In example E1, the correction management unit 15 updates the horizontal correction information and does not update the vertical correction information, which will be explained later in detail by referring to FIG. 8. This is because the correction management unit 15 estimates that “the user performed the first touch manipulation, intending to tap button B2 (i.e., a button that is horizontally close to button B1 and that has a narrow width horizontally)”. As will be explained in detail by referring to FIG. 8, this estimation is based on the following facts.
Because contact area C1 and contact area C2 are overlapping, they are sufficiently close to each other.
The direction of the second touch manipulation relative to the first touch manipulation is nearly horizontal.
The horizontal width of object area G2 is smaller than the width of a finger (for example the width of contact area C1, the width of contact area C2 or the value based on the average value of them).

Incidentally, in addition to a case where a GUI object that the user did not intend to touch was identified as the GUI object that is the target of the first touch manipulation, there can be a case where the user performs a cancellation manipulation. Specifically, the following cases may be possible.
The GUI object intended by the user was correctly identified as the GUI object that is the target of the first touch manipulation.
The application software 12 executed a process in response to the first touch manipulation.
The user was not satisfied with the result of the execution by the application software 12.

As described above, also when the behavior of the application software 12 is not satisfactory, the user may perform a cancellation manipulation.

In such a case, a manipulation sequence of “a first touch manipulation, a cancellation manipulation, and a second touch manipulation” does not suggest that “current horizontal correction information and vertical correction information have not sufficiently entered a state that is adequate”. Accordingly, in this case, it is desirable that the correction management unit 15 update neither the horizontal correction information nor the vertical correction information.

Example E2 is an example of a case where it is desirable that neither the horizontal correction information nor the vertical correction information be updated. Similarly to example E1, the window of the application software 12 is being displayed on the touch screen 11, and web page P1 and a tool bar are being displayed in the window.

When the user has performed a first touch manipulation, the area touched in the first touch manipulation is detected by the position detection unit 13, and the position of the detected area is corrected by the correction management unit 15. The area that had its position thus corrected is contact area C3. Contact area C3 and object area G3 are overlapping.

The correction management unit 15 reports the position of contact area C3 to the application software 12.

On the basis of the report, the application software 12 identifies button B3 as the GUI object that is the target of the first touch manipulation.

As a result of this, as represented by step S20, the application software 12 executes the manipulation associated with button B3. Specifically, in step S20, the application software 12 reads web page P4 specified by the hyperlink embedded in button B3 so as to display web page P4 in the window.

Meanwhile, the manipulation detection unit 16 also recognizes the position of contact area C3. Then, the manipulation detection unit 16 identifies object area G3 as the object area occupied by the GUI object that is the target of the first touch manipulation on the basis of the position of contact area C3.

Also, because the manipulation detection unit 16 monitors the application software 12, the manipulation detection unit 16 detects a jump from web page P1 to web page P4 conducted in step S20. Detecting the jump, the manipulation detection unit 16 reports the detection of the jump to the correction management unit 15. In making this report, the manipulation detection unit 16 also reports to the correction management unit 15 the position and the size of identified object area G3.

In some cases, the user may feel unsatisfied seeing web page P4 that has been displayed. In such a case, the user may tap “Back” button BB, seeking a web page that is more satisfactory.

Also for the tap manipulation on “Back” button BB, the position is detected and corrected by the position detection unit 13 and the correction management unit 15, respectively.

Then, the correction management unit 15 reports the position of the contact area to the application software 12 so that the application software 12 recognizes that the “Back” button BB has been tapped. As a result of this, the application software 12 executes the process of returning to web page P1 from web page P4 in step S21, and web page P1 is displayed again in the window.

Meanwhile, because the manipulation detection unit 16 continues to monitor the application software 12, the manipulation detection unit 16 also detects a manipulation in the application software 12 in step S21. Specifically, the manipulation detection unit 16 detects that the process of cancelling the jump detected in step S20 has been executed in the application software 12. Then, the manipulation detection unit 16 reports the detection result to the correction management unit 15.

The user performs a second touch manipulation on web page P1 that has been displayed again. Specifically, in example E2, the user performs the second touch manipulation, intending to tap button B2.

The area touched in the second touch manipulation is detected by the position detection unit 13, and the position of the detected area is corrected by the correction management unit 15. The area that had its position thus corrected is contact area C4.

The correction management unit 15 reports the position of contact area C4 to the application software 12. As illustrated in FIG. 2, contact area C4 is closer to object area G2 than to object area G1, and the center of contact area C4 is located in object area G2. Accordingly, the application software 12 identifies button B2 as the GUI object that is the target of the second touch manipulation.

As a result of this, as represented by step S22, the application software 12 executes the manipulation associated with button B2. Specifically, in step S22, the application software 12 displays web page P3 in the window similarly to the case in step S12 in example E1.

Meanwhile, the manipulation detection unit 16 also recognizes the position of contact area C4. Then, the manipulation detection unit 16 identifies object area G2 as the object area occupied by the GUI object that is the target of the second touch manipulation on the basis of the position of contact area C4.

Also, because the manipulation detection unit 16 monitors the application software 12, the manipulation detection unit 16 detects a jump from web page P1 to web page P3 conducted in step S22. Detecting the jump, the manipulation detection unit 16 reports the detection of the jump to the correction management unit 15. In making this report, the manipulation detection unit 16 also reports to the correction management unit 15 the position and the size of identified object area G2.

On the basis of the reports from the manipulation detection unit 16 in steps S20, S21 and S22 described above, the correction management unit 15 detects that a series of “a first touch manipulation, a cancellation manipulation for cancelling the first touch manipulation, and a second touch manipulation” was performed sequentially. In response to the detection, the correction management unit 15 determines whether to update the horizontal correction information and whether to update the vertical correction information.

In example E2, the correction management unit 15 updates neither the horizontal correction information nor the vertical correction information because contact area C3 and contact area C4 are apart, and this point will be explained later in detail by referring to FIG. 8.

Because contact area C3 and contact area C4 are apart, the correction management unit 15 estimates that “the user performed the first touch manipulation, intending to tap button B3, and performed the second touch manipulation, intending to tap button B2”. In other words, the correction management unit 15 estimates that “the user performed the first and second touch manipulations having different intentions”. In such a case, updates of the horizontal correction information and/or the vertical correction information may degrade the usability, and accordingly the correction management unit 15 updates neither the horizontal correction information nor the vertical correction information.

Next, by referring to FIG. 3, explanations will be given for relative relationships between the size of a GUI object and the size of an area on the screen touched by a finger of the user.

FIG. 3 exemplifies web pages P10 and P20. Web page P10 includes five GUI objects (specifically, link texts L10 through L14), and web page P20 also includes five GUI objects (specifically, link texts L20 through L24). In the following explanations, a link text will also be referred to simply as a link. In FIG. 3, the areas occupied by links L10 through L14 and L20 through L24 on the touch screen 11 appear as object areas G10 through G14 and G20 through G24.

In the example illustrated in FIG. 3, object areas G11 through G14 are located close to each other. Specifically, object areas G11 and G12 are horizontally adjacent, while object areas G13 and G14 are also horizontally adjacent. Also, object areas G11 and G13 are vertically adjacent, while object areas G12 and G14 are also vertically adjacent. Object areas G11 and G14 are close diagonally, while object areas G12 and G13 are also close diagonally. However, object area G10 is apart from the other object areas G11 through G14.

More specifically, whether two areas are close is determined with respect to the size of the area over which a user's finger contacts the touch screen 11 (more strictly, the size of the area recognized by the position detection unit 13 in response to a touch manipulation). FIG. 3 exemplifies contact area C10 in order to illustrate the size of an area over which a user's finger contacts the touch screen 11.

Contact area C10 is larger than object area G10. Accordingly, when the user attempts to tap link L10, the finger of the user is not entirely included in object area G10.

However, contact area C10 is not so large that when the user has attempted to tap link L10, a different link (for example, link L14 closest to link L10) is identified as the GUI object that is the target of the touch manipulation. In other words, with respect to the size of contact area C10, object area G10 is sufficiently apart from any of the other object areas G11 through G14.

By contrast, with respect to the size of contact area C10, object areas G11 through G14 are sufficiently close to each other. Contact area C10 is not only larger than each of object areas G11 through G14, but also so large that a link other than the link that the user intended to tap is identified as the GUI object that is the target of the touch manipulation.

When for example the user has touched the touch screen 11 intending to tap link L11, there is, as a matter of course, a possibility that “object area G11 will be identified as the GUI object that is the target of the touch manipulation intended by the user”. However, because contact area C10 is larger than object area G11, there is also a possibility that “a link not intended by the user will be identified as the GUI object that is the target of the touch manipulation”.

With respect to for example the size of contact area C10 (specifically, the horizontal width), object area G12 is sufficiently horizontally close to object area G11. Also, with respect to the size of contact area C10 (specifically, the vertical height), the object area G13 is sufficiently vertically close to object area G11. Similarly, with respect to the size of contact area C10 (specifically, the width and height), object area G14 is sufficiently close to object area G11 both horizontally and vertically. Accordingly, when the user has touched the touch screen 11 intending to touch panel link L11, there is a high possibility that one of object areas G12 through G14 will be identified as the GUI object that is the target of the touch manipulation.

As is understood from the above examples too, whether an object area is large is determined with respect to the size of a contact area. Whether two areas are close to each other is also determined with respect to the size of a contact area.

In this example, for comparison with web page P10, an example of web page P20 is referred to. The layout of object areas G20 through G24 on web page P20 is mathematically similar to the layout of object areas G10 through G14 on web page P10.

Also, contact area C20 is exemplified on web page P20 in order to illustrate the size of the area over which a user's finger contacts the touch screen 11 (more strictly, the size of the area recognized by the position detection unit 13 in response to a touch manipulation).

Web pages P10 and P20 may be equal in size or may be different in size. In any of these cases, whether an area is large is determined on the basis of a relative comparison with the size of the contact area, and whether two areas are close to each other is also determined with respect to the size of the contact area. Accordingly, the differences as follow exist between web pages P10 and P20.

On web page P10, each of object areas G10 through G14 is smaller than contact area C10. By contrast, on web page P20, each of object areas G20 through G24 is larger than contact area C20. Accordingly, when for example the user touches the touch screen 11 intending to tap link L21, the possibility that a link that the user did not intend to touch will be identified as the GUI object that is the target of the touch manipulation can be ignored.

Also, on web page P10, object areas G11 through G14 are close to each other with respect to the size of contact area C10. On web page P10, only object area G10 is sufficiently apart from the other object areas with respect to the size of contact area C10. Accordingly, on web page P10, there is a relatively high probability that a link that the user does not intend to touch will be identified as a GUI object that is the target of the touch manipulation.

By contrast, on web page P20, object areas G20 through G24 are sufficiently apart with respect to the size of contact area C20. Accordingly, on web page P20, a probability that a link that the user did not intend to touch will be identified as the GUI object that is the target of the touch manipulation is negligibly low.

For example, the interval between object areas G21 and G22 is narrower than the width of contact area C20. However, it is not likely that the user intending to tap link L21 will touch the misleading rightmost portion of link L21. Also, the distance between the centers of object areas G21 and G22 is sufficiently greater than the width of contact area C20.

Accordingly, the probability that “the user intended to touch link L21, but link L22 is identified as the GUI object that is the target of the touch manipulation” is negligibly low. In other words, object areas G21 and G22 are sufficiently apart with respect to the size of contact area C20. Similarly, object area G21 is apart also from object areas G23 and G24.

As exemplified by referring to web pages P10 and P20 above, the size of an area and the distance between areas are determined on the basis of the size of a contact area in the present embodiment.

Next, by referring to FIG. 4, explanations will be given for an example of hardware for implementing the terminal device 10 illustrated in FIG. 2. As described above, the terminal device 10 may be an arbitrary one of various devices such as a desktop PC, a laptop PC, a tablet PC, a smartphone, a media player, a portable game device, a mobile phone, etc. From a certain point of view, any of these various devices is a type of a computer. In other words, the terminal device 10 may be implemented by the computer 20 as illustrated in in FIG. 4.

The computer 20 includes a CPU (Central Processing Unit) 21 and a chip set 22. Various components in the computer 20 are connected to the CPU 21 via a bus and the chip set 22.

Specifically, a memory 23, a touch screen 24 and a non-volatile storage unit 25 are connected to the chip set 22.

Also, the computer 20 may further include an input device 26 that is not the touch screen 24. The computer 20 may further include a communication interface 27 for transmitting and receiving data with other devices via a network 30. The computer 20 may further include a reader/writer 28 for a storage medium 40. A “reader/writer” is intended to mean “a reader and a writer”. The input device 26, the communication interface 27, and the reader/writer 28 may also be connected to the chip set 22.

The CPU 21 is a single-core processor or a multi-core processor. The computer 20 may include two or more CPUs 21. The memory 23 is for example a DRAM (Dynamic Random Access Memory). The CPU 21 loads a program onto the memory 23 so as to execute the program by using the memory 23 also as a working area.

An example of a program executed by the CPU 21 is the application software 12. Other examples of a program executed by the CPU 21 may include an OS (Operating System), a device driver, firmware, etc. The correction management unit 15 and the manipulation detection unit 16 illustrated in FIG. 2 may also be implemented by the CPU 21.

The touch screen 24 corresponds to the touch screen 11 illustrated in FIG. 2. The touch screen 24 includes many circuit elements used as a sensor for detecting touched positions. As a matter of course, the touch screen 24 includes a display device serving as an output device. The touch screen 24 may be for example a resistive touch screen, a capacitive touch screen, or a touch screen utilizing other technologies.

For example, the CPU 21 may detect the position of the area touched by the user on the touch screen 24 on the basis of a signal output from the touch screen 24. In some embodiments, the CPU 21 may further detect the size of the area or may further detect the shape of the area.

The CPU 21 may detect the position etc. of the area touched by the user on the touch screen 24 by executing a prescribed program (for example, firmware for area detection and/or a device driver of the touch screen 24). In other words, the position detection unit 13 illustrated in FIG. 2 may be implemented by the CPU 21. The position detection unit 13 may be implemented by a combination of a hardware circuit and the CPU 21.

The non-volatile storage unit 25 may be for example an HDD (Hard Disk Drive) or an SSD (Solid-State Drive) or a combination of them. Further, a ROM (Read-Only Memory) may be used as the non-volatile storage unit 25. The correction DB 14 illustrated in FIG. 2 may be stored in the non-volatile storage unit 25 or may also be copied onto the memory 23 from the non-volatile storage unit 25 so as to be stored in the memory 23. The memory 23 and the non-volatile storage unit 25 are examples of a storage device.

Examples of the input device 26 include a keyboard, a hardware switch, a hardware button, a mouse, etc. For example, it is also possible to employ a configuration in which a specific key (or a combination of two or more specific keys) is assigned to a cancellation manipulation in the specific application software 12.

A specific example of the communication interface 27 is a circuit that is suitable for the type of the network 30. The computer 20 may include two or more types of the communication interface 27.

The communication interface 27 may be for example a wired LAN (Local Area Network) interface or may be a wireless LAN interface. More specifically, the communication interface 27 may also be an NIC (Network Interface Card). A network interface controller of an onboard type may be used as the communication interface 27. The communication interface 27 may include a circuit referred to as a “PHY chip”, which performs processes on the physical layer, and a circuit referred to as a “MAC chip”, which performs processes on the MAC (Media Access Control) sublayer.

A wireless communication circuit in accordance with wireless communication standards such as 3GPP (Third Generation Partnership Project), LTE (Long Term Evolution), WiMAX

(Worldwide Interoperability for Microwave Access), etc. may be used as the communication interface 27. “WiMAX” is a registered trademark.

The storage medium 40 may be for example an optical disk such as a CD (Compact Disc), DVD (Digital Versatile Disc), etc. may be for example a magneto-optical disk, or may be for example a magnetic disk. A non-volatile semiconductor memory (for example, a memory card, a USB (Universal Serial Bus), a memory stick, etc.) may be used as the storage medium 40.

Specific examples of the reader/writer 28 may include a disk drive device and a card reader/writer for memory card. Alternatively, a USB controller connected to a USB port may be used as the reader/writer 28.

Various programs executed by the CPU 21 may have been installed in the non-volatile storage unit 25 in advance. The programs may be downloaded from the network 30 via the communication interface 27 so as to be stored in the non-volatile storage unit 25. The programs may be stored in the storage medium 40 in advance. Programs stored in the storage medium 40 may be read by the reader/writer 28 so as to be copied onto the non-volatile storage unit 25.

All of the memory 23, the non-volatile storage unit and the storage medium 40 are examples of a tangible computer-readable storage medium. These tangible storage media are not transitory media such signal carrier waves.

Next, by referring to FIG. 5, explanations will be given for some examples of data formats of the correction DB 14 illustrated in FIG. 2. The correction DB 14 may be a DB having an arbitrary one of the formats of correction DBs 14a through 14e illustrated in FIG. 5, or may be a DB having a different format.

Note that for convenience of explanation below, the horizontal coordinate axis is treated as the X axis and the vertical coordinate axis is treated as the Y axis.

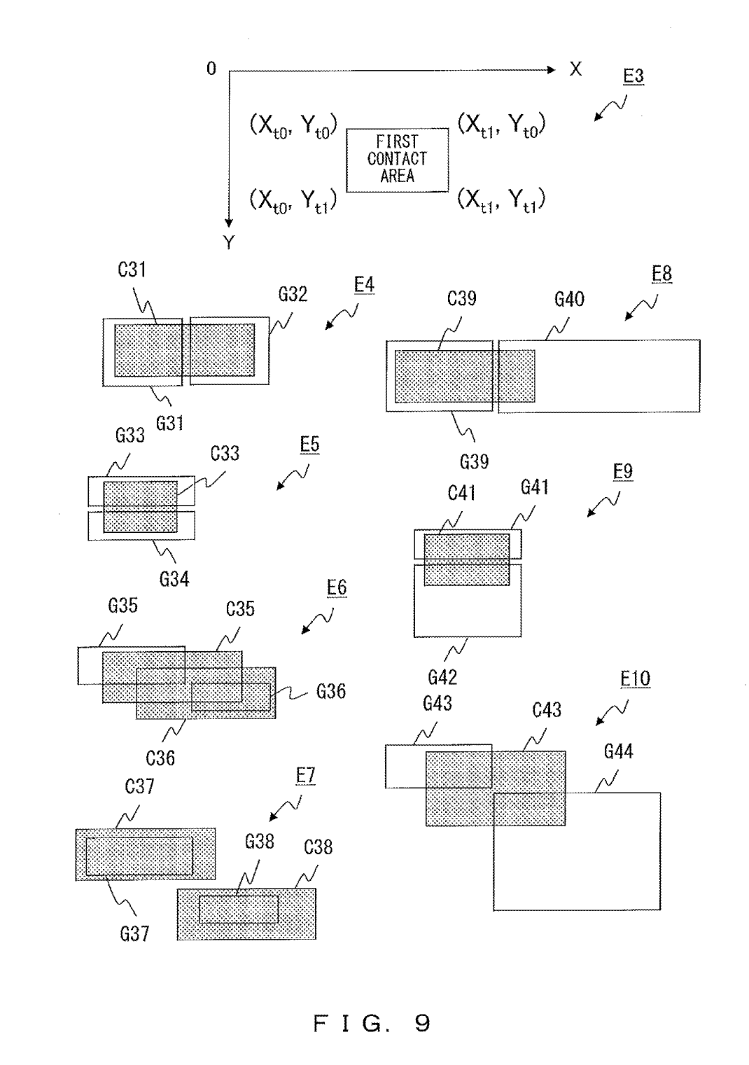

Specifically, as will be illustrated in FIG. 9 later, the upper left corner of the touch screen 11 is treated as the origin.

Positions on the touch screen 11 are represented by using X and Y coordinates. For example, the detection of a position by the position detection unit 13 is specifically the detection of the X and Y coordinates. The correction management unit 15 corrects X and Y coordinates so as to report the corrected X and Y coordinates to the application software 12.

Also, in the following explanations, a correction value in the X directions (i.e., the horizontal directions) is referred to as “ΔX” and a correction value in the Y directions (i.e., the vertical directions) is referred to as “ΔY”. Correction value ΔX is an example of horizontal correction information while correction value ΔY is an example of vertical correction information.

The correction DB 14a is a DB that stores one correction value ΔX and one correction value ΔY. FIG. 5 exemplifies a case where ΔX=3 and ΔY=−2 are satisfied.

When the correction DB 14a is used, the correction management unit 15 adds correction value ΔX to the value of the X coordinate detected by the position detection unit 13, and corrects the X coordinate. Also, the correction management unit 15 adds correction value ΔY to the value of the Y coordinate detected by the position detection unit 13, and corrects the Y coordinate.

The correction DB 14b has a plurality of entries. Each entry includes a pair of the X and Y coordinates, correction value ΔX and a correction value Y for identifying a block on the touch screen 11.

It is possible for example to define, as one block, a scope of (X,Y) meeting condition (1) for integers i and j that are equal to or greater than zero. Nx and Ny are constants in condition (1).

Nx·i≦X<Nx·(i+1) and

Ny·jY≦Ny·(j+1) (1)

A block defined by condition (1) may be identified by the X and Y coordinates of (Nx·i,Ny·j). FIG. 5 exemplifies the correction DB 14b used when Nx=64 and Ny=64 are satisfied.

The three entries exemplified in the correction DB 14b represent the following facts.
Correction value ΔX corresponding to a block defined by a condition of “64≦X<128 and 192≦Y<256” is −1, and correction value ΔY corresponding to this block is 4.
Correction value ΔX corresponding to a block defined by a condition of “64≦X<128 and 256≦Y<320” is zero, and correction value ΔY corresponding to this block is 3.
Correction value ΔX corresponding to a block defined by a condition of “128≦X<192 and 256≦Y<320” is 2, and correction value ΔY corresponding to this block is 3.

When the correction DB 14b is used, the correction management unit 15 uses the correction value ΔX and correction value ΔY corresponding to a block to which the position represented by the X and Y coordinates detected by the position detection unit 13 belongs, and thereby corrects the X and Y coordinates. When for example the position detection unit 13 has detected the X and Y coordinates of (X,Y)=(100,200), the correction management unit 15 uses −1 and 4 as the correction value ΔX and the correction value ΔY. Accordingly, the correction management unit 15 calculates 99 (=100−1) as the value of the corrected X coordinate and also calculates 204 (=200+4) as the value of the corrected Y coordinate.

The correction DB 14c also has a plurality of entries. Each entry has the following fields.
X and Y coordinates for identifying a block on the touch screen 11
Two values for specifying the scope of the width and height of a GUI object (for example, the upper limits of the width and height)
Type of GUI object above
Correction value ΔX and correction value ΔY

Compared with the correction DB 14b, three fields have been added to the correction DB 14c. The correction DB 14c is also an example of a case when Nx=64 and Ny=64 are satisfied.

In the correction DB 14c, five entries are exemplified. These five entries are used for determining the correction value ΔX and the correction value ΔY used when the position detected by the position detection unit 13 belongs to a block defined by a condition of “320≦X<384 and 128≦Y<192”.
When a position detected by the position detection unit 13 belongs to the above block and is included in an area in which a radio button with a width of 12 or smaller and a height of 12 or smaller has been arranged, correction value ΔX=2 and correction value ΔY=−3 are used
When a position detected by the position detection unit 13 belongs to the above block and is included in an area in which a link text with a width of 36 or smaller and a height of 12 or smaller has been arranged, correction value ΔX=2 and correction value ΔY=−2 are used
When a position detected by the position detection unit 13 belongs to the above block and is included in an area in which a link text with a width greater than 36 and equal to or smaller than 72 and a height of 12 or smaller has been arranged, correction value ΔX=0 and correction value ΔY=−2 are used
When a position detected by the position detection unit 13 belongs to the above block and is included in an area in which a dropdown list with a width of 36 or smaller and a height of 24 or smaller has been arranged, correction value ΔX=1 and correction value ΔY=−3 are used
When a position detected by the position detection unit 13 belongs to the above block and no GUI object has been arranged in the detected position, correction value ΔX=1 and correction value ΔY=−2 are used

When the correction DB 14c is used, the correction management unit 15 identifies the block to which the position represented by the X and Y coordinates detected by the position detection unit 13 belongs. Also, the correction management unit 15 inquires of the manipulation detection unit 16 as to whether there is a GUI object that occupies an area including the position detected by the position detection unit 13 (i.e., the point represented by the X and Y coordinates detected by the position detection unit 13). The manipulation detection unit 16 replies to the inquiry.

Specifically, when there is a GUI object that occupies an area including the point represented by the X and Y coordinates reported from the correction management unit 15, the manipulation detection unit 16 reports the width, height and type of that GUI object to the correction management unit 15. When there is not such a GUI object as described above, the manipulation detection unit 16 reports to the correction management unit 15 that there is not a GUI object as described above.

When the manipulation detection unit 16 has reported to touch correction management unit 15 the width, height and type of the GUI object, the correction management unit 15 searches for an entry corresponding to the combination of the width, height and type reported from the manipulation detection unit 16. Then, the correction management unit 15 uses the correction value ΔX and the correction value ΔY that have been found.

When the manipulation detection unit 16 has reported to the correction management unit 15 that there is not a GUI object as described above, the correction management unit 15 searches for an entry in which invalid values are set in the fields of width, height and type from among entries corresponding to the block identified as described above. Then, the correction management unit 15 uses the correction value ΔX and the correction value ΔY of the entry that has been found.

Next, explanations will be given for a correction DB 14d. The correction DB 14d also has a plurality of entries. Each entry includes identification information for identifying application software, correction value ΔX and correction value ΔY. The two entries exemplified in the correction DB 14d represent the following facts.
When a touch manipulation has been performed in the application software 12 identified by the application name of “web browser”, correction value ΔX=−3 and correction value ΔY=2 are used
When a touch manipulation has been performed in the application software 12 identified by the application name of “music player”, correction value ΔX=−5 and correction value ΔY=−1 are used

When the correction DB 14d is used, the correction management unit 15 identifies the application software 12 that is the target of a touch manipulation, and corrects the X and Y coordinates by using the correction value ΔX and correction value ΔY corresponding to the identified application software 12. The correction management unit 15 may use the X and Y coordinates detected by the position detection unit 13 so as to identify the application software 12 that is the target of a touch manipulation via for example an OS or an appropriate API.

The correction DB 14e also has a plurality of entries. Each entry includes a pair of the X and Y coordinates for identifying a block on the touch screen 11, correction value ΔX, correction value ΔY and a counter. As compared with the correction DB 14b, a counter has been added to the correction DB 14e.

A counter is used for calculating correction value ΔX and/or correction value ΔY after being updated when the correction management unit 15 updates correction value ΔX and/or correction value ΔY. Calculations utilizing a counter will be described later by referring to FIG. 8.

A value of a counter represents the number of times that a process of updating correction value ΔX and/or correction value ΔY has been performed up to the present in relation to the entry including that counter. In some embodiments, two counters may be used for each entry instead of using one counter for each entry such as in the correction DB 14e. In other words, it is possible to use a first counter for representing the number of times up to the present that correction value ΔX has been updated and a second counter for representing the number of times up to the present that correction value ΔY has been updated.

A counter is not used when the correction management unit 15 corrects the position detected by the position detection unit 13. Accordingly, when the correction DB 14e is used, the correction management unit 15 corrects the position similarly to a case where the correction DB 14b is used.

Note that when the correction DB 14a is used, zero may be set as the initial value of correction value ΔX, and zero may also be used as the initial value of correction value ΔY. When the correction DB 14 having a format including a plurality of entries such as the correction DBs 14b through 14e is used, zero may be set as the initial value of the correction value ΔX and as the initial value of the correction value ΔY in each entry.

Also, when the correction DB 14 having a format including a plurality of entries is used, it is not always necessary for the initial state to have all entries. When for example the correction management unit 15 has searched the correction DB 14 in order to determine correction value ΔX and correction value ΔY and no entry that meets the search condition has been found, the correction management unit 15 may add to the correction DB 14 a new entry that meets the search condition. The correction management unit 15 may initialize the correction values ΔX and correction value ΔY of the new entry to zero.

Note that the correction DB 14 having a format that is different from the formats of the correction DBs 14a through 14e exemplified in FIG. 5 may also be used.

For example, it is possible to omit, from the correction DB 14c, the fields for the X coordinate and Y coordinate that are for identifying a block. The fields for width and height may be omitted from the correction DB 14c, or the field for type may be omitted from the correction DB 14c.

It is also possible to add the fields for X coordinate and Y coordinate for identifying a block to the correction DB 14d. It is also possible to add the fields for width and height of a GUI object to the correction DB 14d. It is also possible to add the field for type of a GUI object, or to add all the fields for width, height and type. In other words, for each function represented by a GUI object, a piece of application software or a combination of them, correction value ΔX and correction value ΔY may be defined.

In the above examples of the correction DB 14b and the correction DB 14c, the plurality of blocks on the touch screen 11 have a fixed size. Accordingly, the fields for the X coordinate and Y coordinate are sufficient as the fields for identifying a block in the correction DB 14b and the correction DB 14c. However, in some embodiments, blocks having different sizes may be defined. For example, each block on the touch screen 11 may be identified by a combination of the X and Y coordinates of the upper left corner of a block, the width of the block and the height of the block. As a matter of course, only one of the width and height of a block may be variable between a plurality of blocks. For example, both the correction DB 14b and the correction DB 14c may be modified to have further fields for either of width and height of a block or for both of them in addition to the fields for the X coordinate and Y coordinate as fields for identifying a block.

Also, fields for a counter such as that exemplified in the correction DB 14e may be added to the correction DB 14 that has any other formats. A field for a counter may be added to for example any of the correction DBs 14a, 14c and 14d.

When the terminal device 10 includes an orientation sensor, a field representing the orientation of the terminal device 10 may be included in each entry in the correction DB 14. In such a case, the correction management unit 15 obtains orientation information, which represents the orientation of the terminal device 10 via for example a prescribed API, and searches the correction DB 14 for an entry corresponding to the obtained orientation information. Then, the correction management unit 15 corrects the correction value ΔX and the correction value ΔY in the found entries. An example of orientation information may be a combination of a pitch angle and a roll angle.

As exemplified above, the correction DB 14 may store only one correction value ΔX and only one correction value ΔY, and may store horizontal correction information and vertical correction information so that they respectively correspond to a plurality of conditions that were determined. The plurality of conditions that were determined as described above will also be referred to as “a plurality of correction conditions” hereinafter. One correction condition corresponds to one entry in the correction DB 14 in the example illustrated in FIG. 5.

A plurality of correction conditions may be a plurality of positional conditions related to what portion was touched on the touch screen 11. In the correction DBs 14b, 14c and 14e, each positional condition is expressed by the fields for X and Y coordinates for identifying a block. As a matter of course, it is also possible to further use one or both of the fields for width and height of a block in order to identify a block as described above. In other words, each positional condition may be expressed by the fields for X and Y coordinates and one or both of the fields for width and height of a block.

A plurality of correction conditions may be for example a plurality of orientational conditions regarding the orientation of the touch screen. For example, each orientational condition may be expressed by a combination of the scope of the pitch angle and the scope of the roll angle.

A plurality of correction conditions may be for example a plurality of application conditions related to what piece of application software a touch manipulation has been performed on. In the correction DB 14d, each application condition is expressed by the identification information of the application software.

A plurality of correction conditions may be for example a plurality of object conditions related to the property of a GUI object occupying an area that is at least partially overlapping the area detected by the position detection unit 13. The property of a GUI object may be expressed by for example a width, a height, a type or a combination of two or more of them. In the correction DB 14c, each object condition is expressed by a combination of a width, a height and a type.

As a matter of course, a plurality of correction conditions may be a plurality of conditions that are expressed by a combination of two or more conditions from among a plurality of positional conditions, a plurality of orientational conditions, a plurality of application conditions, and a plurality of object conditions. In any case, when the correction DB 14 stores correction value ΔX and correction value ΔY so that they respectively correspond to a plurality of correction conditions, the correction management unit 15 uses the correction value ΔX and the correction value ΔY that correspond to a correction condition that is met from among a plurality of correction conditions.

Also, as will be described in detail by referring to FIG. 8 through FIG. 10, there may be a case where the correction management unit 15 updates correction value ΔX and/or correction value ΔY in response to a manipulation sequence of “a first touch manipulation, a cancellation manipulation, and a second touch manipulation”. Specifically when the correction management unit 15 updates correction value ΔX, the correction management unit 15 updates correction value ΔX corresponding to a specific correction condition that was met in the first touch manipulation from among a plurality of correction conditions. Similarly, specifically, when the correction management unit 15 is to update correction value ΔY, the correction management unit 15 updates correction value ΔY corresponding to the above specific correction condition.

More detailed explanations will be given for the operations of the terminal device 10 by referring to the flowcharts illustrated in FIG. 6 through FIG. 8 and to FIG. 9 and FIG. 10.

FIG. 6 is a flowchart of a coordinate report process. A coordinate report process is a process related to the detection of a touch manipulation and the correction of coordinates, and is executed each time the user performs a touch manipulation.

In step S101, the position detection unit 13 detects the area touched in the touch manipulation. The position detection unit 13 may detect only the position of the area touched in the touch manipulation. In such a case, the position detection unit 13 estimates that the size of the area touched in the touch manipulation is a size that is defined by at least one value that is stored in advance. Alternatively, the position detection unit 13 may detect the position and the size of the area and also may detect the position, the size and the shape of the area.

For the sake of convenience of explanation below, it is assumed that the position detection unit 13 detects a bounding box touched in a touch manipulation. It is also assumed that the upper left corner of the touch screen 11 is the origin of the X-Y coordinate system as illustrated in FIG. 9, which will be explained later. It is also assumed that the bounding box detected by the position detection unit 13 is a scope that meets condition (2).

Xs≦X≦Xe and Ys≦Y≦Ye (2)

The position detection unit 13 reports to the correction management unit 15 the coordinates (Xs,Ys) and (Xe,Ye) that represent the detected area. In other words, the position detection unit 13 reports the position and the size of the detected area to the correction management unit 15. By reporting to the correction management unit 15 the coordinates (Xs,Ys) and (Xe,Ye) that represent the detected area, the position detection unit 13 reports to the correction management unit 15 the coordinates (Xc,Yc) representing the position of the detected area, and width W and height H of the detected area (See numerical expressions (3) through (6)).

Xc=(Xs+Xe)/2 (3)

Yc=(Ys+Ye)/2 (4)

W=Xe−Xs (5)

H=Ye−Ys (6)

Then, the correction management unit 15 obtains the correction value ΔX for the X direction and the correction value ΔY for the Y direction from the correction DB 14 in step S102. The detailed process in step S102 is in accordance with the data format of the correction DB 14.

For example, the correction management unit 15 may read the correction value ΔX and the correction value ΔY from the correction DB 14a. The correction management unit 15 may read, from the correction DB 14b or the correction DB 14e, the correction value ΔX and the correction value ΔY corresponding to a block to which the coordinates (Xc,Yc) belong.

The correction management unit 15 may inquire of the manipulation detection unit 16 as to whether there is a GUI object that occupies an area including coordinates (Xc,Yc) so as to read from the correction DB 14c the correction value ΔX and the correction value ΔY corresponding to the response to the inquiry. The correction management unit 15 may identify the application software 12 that is the target of a touch manipulation so as to read from the correction DB 14d the correction value ΔX and the correction value ΔY corresponding to the identified application software 12.

Note that when correction value ΔX or correction value ΔY corresponding to a block to which coordinates (Xc,Yc) belong is not registered in the correction DB 14b or the correction DB 14e (i.e., when there is no entry corresponding to the block), the correction management unit 15 estimates correction value ΔX and correction value ΔY to be zero. Similarly, when correction value ΔX and correction value ΔY meeting the above condition are not registered in the correction DB 14c or the correction DB 14d, the correction management unit 15 estimates correction value ΔX and correction value ΔY to be zero.

When an entry meeting a condition is not found as described above, the correction management unit 15 adds a new entry to the correction DB 14. The correction value ΔX and the correction value ΔY in a new entry are initialized to zero.

As a matter of course, there is a possibility that a registered correction value ΔX is zero. Similarly, there is a possibility that a registered correction value ΔY is zero.

Next, in step S103, the correction management unit 15 calculates coordinates (Xc+ΔX,Yc+ΔY) after the correction. In some embodiments, the correction management unit 15 may determine whether the correction value ΔX is zero and may perform an addition of “Xc+ΔX” only when the correction value ΔX is not zero. Similarly, the correction management unit 15 may determine whether the correction value ΔY is zero and may perform an addition of “Yc+ΔY” only when the correction value ΔY is not zero.

Then, in step S104, the correction management unit reports corrected coordinates (Xc+ΔX,Yc+ΔY) to the application software 12 and the manipulation detection unit 16. Then, the coordinate report process is completed.

Note that the correction management unit 15 may report corrected coordinates (Xc+ΔX,Yc+ΔY) in step S104 only to the application software 12. The manipulation detection unit 16 can recognize corrected coordinates (Xc+ΔX,Yc+ΔY) by hooking the report to the application software 12.

In some embodiments, the correction management unit 15 may calculate coordinates (Xs+ΔX,Ys+ΔY) and (Xe+ΔX,Ye+ΔY) in step S103. Then, the correction management unit 15 may report coordinates (Xs+ΔX,Ys+ΔY) and (Xe+ΔX,Ye+ΔY) to the application software 12 and the manipulation detection unit 16 in step S104.

Note that the correction management unit 15 stores, in for example the memory 23, information that directly or indirectly represents the position detected by the position detection unit 13, the corrected position, and the size of the area for the correction DB update process that will be described later by referring to FIG. 8. For example, the correction management unit 15 may store, in the memory 23, the correction value ΔX and the correction value ΔY obtained in step S102, the corrected coordinates (Xc+ΔX,Yc+ΔY), width W and height H. As another example, the correction management unit 15 may store, in the memory 23, coordinates (Xc,Yc), (Xs+ΔX,Ys+ΔY) and (Xe+ΔX,Ye+ΔY).

The area represented by (Xs+ΔX,Ys+ΔY) and (Xe+ΔX,Ye+ΔY) is a “contact area” explained by referring to FIG. 1 and FIG. 2. In other words, the contact area is an area that is located in the area represented by coordinates (Xc+ΔX,Yc+ΔY) and that has width of W and height of H.

After the completion of the coordinate report process, the application software 12 operates in accordance with coordinates (Xc+ΔX,Yc+ΔY). When for example the position represented by coordinates (Xc+ΔX,Yc+ΔY) belongs to an ineffective area (for example an area in which normal text other than a link text is written, or an area of a normal image in which no hyperlink is embedded, etc.), the application software 12 does not perform any processes. Accordingly, in such a case, the manipulation detection unit 16 detects no manipulations in the application software 12.

When coordinates (Xc+ΔX,Yc+ΔY) belong to an area occupied by a GUI object for making the application software 12 execute some process, the application software 12 executes that “some process”. For example, when the following three conditions are met, the application software 12 executes a jump from web page P1 to web page P4 illustrated in FIG. 2. Then, this jump is detected by the manipulation detection unit 16.
The application software 12 is a web browser
When the application software 12 was displaying web page P1 illustrated in FIG. 2, the correction management unit 15 reported coordinates (Xc+ΔX,Yc+ΔY) to the application software 12
Coordinates (Xc+ΔX,Yc+ΔY) are in object area G3.

Separately from the coordinate report process described above, a correction DB management process related to the management of the correction DB 14 is performed. The correction DB management process includes the following.
Monitoring whether a specific manipulation sequence of “a first touch manipulation, a cancellation manipulation and a second touch manipulation” has been performed
Determining “whether to update only correction value ΔX, only correction value ΔY, both correction value ΔX and correction value ΔY, or neither correction value ΔX nor correction value ΔY” when a specific manipulation sequence has been detected
Operating in accordance with the determination regarding the update of the correction DB 14

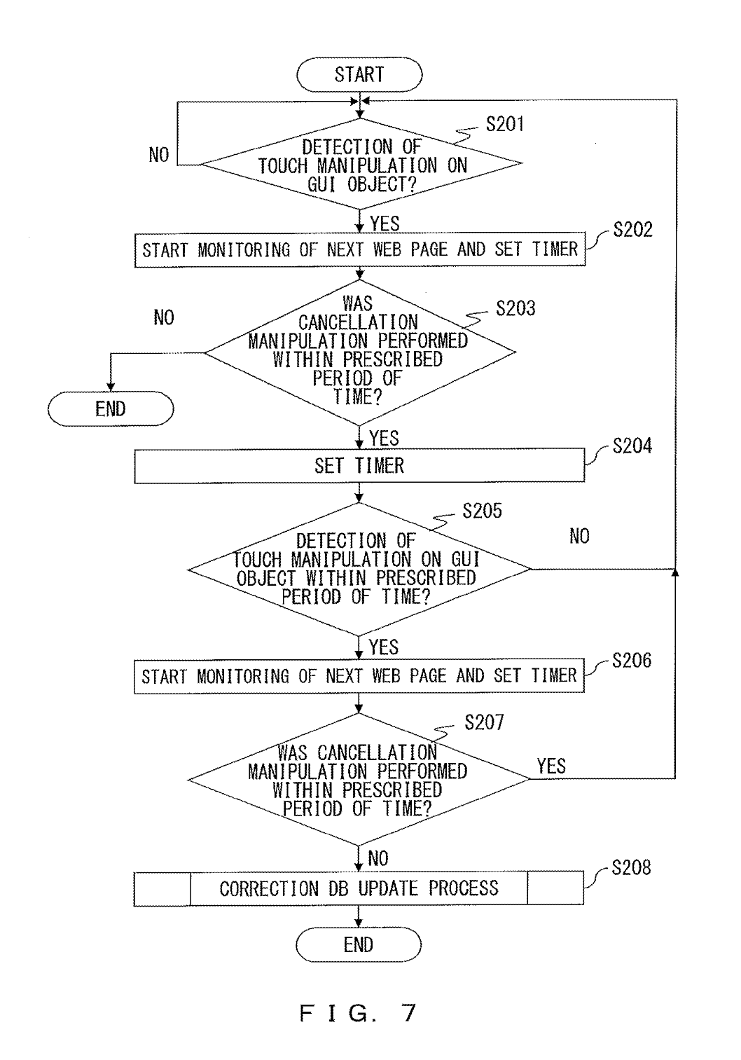

Specific implementations of a correction DB management process may vary in accordance with embodiments. For example, when the application software 12 is a web browser, the correction management unit 15 may perform a separate process for each web page displayed by the web browser so as to monitor a specific manipulation sequence. FIG. 7 is a flowchart for a monitoring process performed for each web page. Also, the correction management unit 15 may conduct determination regarding updating of the correction DB 14 in accordance with for example the flowchart illustrated in FIG. 8 so as to operate in accordance with the determination.

Next, the flowcharts illustrated in FIG. 7 and FIG. 8 will be explained. Each time the application software 12 reads a web page to display it in a window, the correction management unit 15 starts the execution of the monitoring process illustrated in FIG. 7 for that web page. The correction

DB update process illustrated in FIG. 8 is called from step S208 illustrated in FIG. 7 in response to the detection of a specific manipulation sequence.

Note that for the sake of convenience of explanation below, the web page monitored as a web page that can be the starting point of the specific manipulation sequence of “a first touch manipulation, a cancellation manipulation and a second touch manipulation” is referred to as a “target web page”. At any given moment, the web page itself being displayed currently in a window of the application software 12 (i.e., a web browser) is the target web page. However, as will be described later in detail, a page different from the one being displayed currently may be the target web page.

When the application software 12 has read a web page and displayed that web page in a window, the correction management unit 15 starts the monitoring process illustrated in FIG. 7 for that web page. In other words, a web page newly displayed in a window is the target web page.

For example, when the application software 12 has displayed a new web page, the manipulation detection unit 16 detects the display of the new web page. In response to the detection, the manipulation detection unit 16 reports to the correction management unit 15 the fact that a new web page has been displayed. Then, the correction management unit 15 starts the monitoring process illustrated in FIG. 7 for that new web page in response to the report. In such a case, the above new web page is the target web page.

In step S201, the correction management unit 15 waits for a touch manipulation to be detected on one of the GUI objects in the target web page. At the moment of step S201, the target web page is a web page that is being displayed currently.

As described above, there is a possibility that the user will perform a touch manipulation in an ineffective area. Therefore, it is not always the case that all touch manipulations cause a manipulation in the application software 12. When the coordinate report process illustrated in FIG. 6 is executed in response to a touch manipulation and the execution caused a manipulation to be performed in the application software 12, the manipulation in the application software 12 is detected by the manipulation detection unit 16.

Then, the manipulation detection unit 16 reports the detection result to the correction management unit 15.

Accordingly, the correction management unit 15 specifically waits for a report from the manipulation detection unit 16 in step S201. A report from the manipulation detection unit 16 includes information representing an object area identified by the manipulation detection unit 16. Receiving a report from the manipulation detection unit 16, the correction management unit 15 stores the information representing the object area in for example the memory 23.

Incidentally, a report from the manipulation detection unit 16 to the correction management unit 15 is made each time a manipulation in the application software 12 is detected. Also, a manipulation in the application software 12 is detected each time a touch manipulation is detected. Also, the coordinate report process illustrated in FIG. 6 is executed for each touch manipulation so that the coordinates of the contact area are obtained.

In other words, in an object area identified in response to a touch manipulation, there is a contact area that corresponds to that object area. “A contact area that corresponds to that object area” is specifically a contact area that had its position detected and corrected in response to the above touch manipulation.

The correction management unit 15 also stores, in for example the memory 23, not only information representing an object area but also information representing the contact area corresponding to that object area. As explained in relation to the coordinate report process illustrated in FIG. 6, each time a touch manipulation is performed, the correction management unit 15 stores, in for example the memory 23, information that directly or indirectly represents the position detected by the position detection unit 13, the corrected position, and the size of the area. For example, the correction management unit 15 may make the above information stored in relation to a contact area in a coordinate report process correspond to information representing an object area in response to the detection in step S201.

In order to manage a correspondence relationship between object areas and contact areas, the correction management unit 15 and the manipulation detection unit 16 may use appropriate identification information (for example, the time stamp at the time when a touch manipulation was detected or a sequence number, etc.). For example, identification information may be included in a report from the correction management unit 15 to the application software 12 and the manipulation detection unit 16 and a report from the manipulation detection unit 16 to the correction management unit 15.

When the correction management unit 15 has recognized, on the basis of a report from the manipulation detection unit 16, that a touch manipulation has been detected on one of the GUI objects in the target web page, the correction management unit 15 operates as below in step S202.

The correction management unit 15 starts monitoring of the next web page. “Next web page” used herein is a web page displayed newly in a window by the application software 12 in response to a touch manipulation. Accordingly, the web page being displayed at the moment of step S202 is a “next web page” and is not the “target web page”.

More specifically, in step S202 the correction management unit 15 starts the monitoring process related to the next web page separately from the monitoring process related to the target web page. For example, the correction management unit 15 may generate a new process corresponding to the next web page in step S202 so as to start the monitoring process related to the next web page.

Also, in step S202, the correction management unit 15 sets a timer related to the target web page. For example, the correction management unit 15 may set a prescribed period of time such as “3 seconds” in the timer. The length of the period of time set in the timer may be a constant, may be a value that has been learned dynamically, or may be a value specified by the user. For the sake of convenience in the explanations below, it is assumed that a prescribed period of time is set in the timer. The correction management unit 15 may make a process for the target web page sleep during the period of time set in the timer.

It is assumed for example that web page P1 is the target web page in example E1 illustrated in FIG. 2. When the user has performed a touch manipulation and the coordinate report process illustrated in FIG. 6 has been executed in response to the touch manipulation, contact area C1 is recognized and a jump in step S10 is executed. As a result of this, web page P2 is displayed.

Then, the manipulation detection unit 16 identifies object area G1 and detects the jump. Thereafter, the manipulation detection unit 16 reports the coordinates representing object area G1 and also reports to the correction management unit 15 the fact that a jump has been detected. The manipulation detection unit 16 may further report to the correction management unit 15 identification information for identifying web page P1 (i.e., the web page on which the touch manipulation has been performed). Identification information may be for example a URI (Uniform Resource Identifier).

Then, the correction management unit 15 recognizes that a touch manipulation has been detected on a GUI object in the target web page (i.e., web page P1). Accordingly, in next step S202, the correction management unit 15 starts the monitoring process related to the next web page (i.e., web page P2), and sets the timer for web page P1.

It is assumed as another example that web page P1 is the target web page in example E2 illustrated in FIG. 2. In such a case, when the jump in step S20 is performed, the correction management unit 15 starts the monitoring process related to the next web page (i.e., web page P4) in step S202, and sets the timer for web page P1.

Thereafter, the correction management unit 15 determines in step S203 that a cancellation manipulation (for example, a touch manipulation on “Back” button BB) was performed within a prescribed period of time. The “prescribed period of time” used herein is a period of time set in the timer in step S202. In other words, the correction management unit 15 determines whether a cancellation manipulation for cancelling the first touch manipulation was performed within a prescribed period of time after the first touch manipulation was performed.

When a cancellation manipulation was performed within a prescribed period of time after the first touch manipulation was performed on the target web page, the monitoring process related to the target web page proceeds to step S204. At the moment of step S204, the target web page is being displayed in the window of the application software 12 again.

When there is not a cancellation manipulation within a prescribed period of time after the first touch manipulation was performed on the target web page (i.e., when time-out has occurred), the monitoring process related to the target web page is terminated. Note that the execution of the monitoring process related to a web page displayed in response to the first touch manipulation (i.e., “next web page” explained in step S202) is continued.

It is assumed for example that the target web page is web page P1 in example E1 illustrated in FIG. 2. It is also assumed that there was not a cancellation manipulation (i.e., a touch manipulation on “Back” button BB) within a prescribed period of time after the execution of the jump in step S10 in response to the first touch manipulation as described above.

In such a case, the correction management unit 15 terminates the monitoring process related to web page P1, because the fact that “cancellation manipulation is not performed within a prescribed period of time after the execution of first touch manipulation” suggests that “the GUI object that the user intended to touch was identified as the target of the touch manipulation correctly”. Accordingly, in such a case, the correction management unit 15 terminates the monitoring process related to the target web page without updating the correction DB 14.

However, the correction management unit 15 continues the monitoring process related to web page P2 (i.e., the web page being displayed currently). Because there is a possibility that a touch manipulation will be performed from then on web page P2, a cancellation manipulation is performed for cancelling that touch manipulation and thereafter a touch manipulation is again performed on web page P2.

There is also a possibility that a cancellation manipulation will be performed on web page P2 after a period of time longer than the prescribed period of time has elapsed. In such a case, when web page P1 has been displayed again in response to the cancellation manipulation, the correction management unit 15 newly starts the monitoring process related to web page P1.

The determination in step S203 will be exemplified in more detail hereinafter.

A cancellation manipulation is performed on a web page that is being displayed currently. The web page being displayed at the moment of step S203 is not a target web page. When for example the target web page is web page P1 and web page P2 is being displayed currently in example E1 illustrated in FIG. 2, a cancellation manipulation is performed on web page P2.

When a cancellation manipulation has been performed, the manipulation detection unit 16 detects the cancellation manipulation. Then, the manipulation detection unit 16 may report to the correction management unit 15 the identification information for identifying the web page for which the cancellation manipulation has been performed (i.e., the web page being displayed currently).

Receiving a report from the manipulation detection unit 16, the correction management unit 15 recognizes that a cancellation manipulation has been performed. When for example the correction management unit 15 uses a separate process for executing a monitoring process for each web page as described above, the correction management unit 15 may operate as described below in response to a report from the manipulation detection unit 16.

The correction management unit 15 wakes up a parent process (or sends a signal to a parent process) from a process related to the web page for which the cancellation manipulation was performed. As understood from the explanations on step S202, the parent process is a process related to the web page being displayed previously to the web page for which the cancellation manipulation was performed. Then, the correction management unit 15 terminates the process related to the web page for which the cancellation manipulation was performed.

When for example “Back” button BB was tapped on web page P2 in example E1 illustrated in FIG. 2, the correction management unit 15 wakes up a process related to web page P1 from a process related to web page P2. Also, in such a case, the correction management unit 15 terminates the process related to web page P2.

Note that, more strictly, when a cancellation manipulation was performed after the prescribed period of time has elapsed after the first touch manipulation, the process related to web page P1 had already been terminated due to time-out. In such a case, there is no process that is in a sleep state related to web page P1. Accordingly, in such a case, the correction management unit 15 generates and starts a process related to web page P1 newly instead of waking up a process in a sleep state related to web page P1.

Meanwhile, the correction management unit 15 executes the determination in step S203 in the above parent process. Specifically, the correction management unit 15 executes the determination in step S203 in the process woken up in response to the cancellation manipulation (or the process that received a signal in response to the cancellation manipulation).

It is assumed for example that in example E1 illustrated in FIG. 2, a cancellation manipulation was performed on web page P2 within a prescribed period of time after the jump in step S10. In such a case, the correction management unit 15 determines that “a cancellation manipulation was performed within a prescribed period of time” in step S203 in the process related to web page P1 in step S203 after it was woken up. Specifically, when the parent process was woken up by a child process before the period of time set by the parent process in step S202 has elapsed, it is determined that “a cancellation manipulation was performed within a prescribed period of time” in step S203 in the parent process.

As a matter of course, the detailed information about step S203 explained above is an example of implementation. Other implementation methods may appropriately be employed in accordance with embodiments. However, in any case, when a cancellation manipulation has been performed within a prescribed period of time after the execution of a first touch manipulation, the correction management unit 15 sets the timer related to the target web page again in step S204.

The period of time set in the timer in step S204 may be equal to the period of time set in step S202 or may be different from it. Also, the length of the period of time set in the timer may be a constant, may be a value that has been learned dynamically or may be a value specified by the user. For the sake of convenience in the explanations below, it is assumed that a prescribed period of time is set in the timer.

Incidentally, each time the user performs a touch manipulation, the coordinate report process illustrated in FIG. 6 is executed independently from the monitoring process illustrated in FIG. 7. Accordingly, there is a possibility that the correction management unit 15 will receive a report from the manipulation detection unit 16 after the execution of step S204.

Specifically, there is a case where the coordinate report process illustrated in FIG. 6 is performed in response to the second touch manipulation, some manipulation is performed in the application software 12 as a result of this, and the manipulation in the application software 12 is detected by the manipulation detection unit 16. In such a case, the manipulation detection unit 16 reports the detection result to the correction management unit 15. A report from the manipulation detection unit 16 includes information representing the second object area identified by the manipulation detection unit 16.

The correction management unit 15 recognizes the second touch manipulation in the target web page on the basis of the report from the manipulation detection unit 16. Also, receiving the report from the manipulation detection unit 16, the correction management unit 15 stores information representing the second object area in for example the memory 23. Similarly to the operation in response to the detection of the first touch manipulation in step S201, the correction management unit 15 also stores, in response to the detection of the second touch manipulation, information representing the second contact area that corresponds to the second object area in for example the memory 23.

As described above, there is a possibility that the correction management unit 15 will receive a report from the manipulation detection unit 16. Accordingly, the correction management unit 15 determines in step S205 whether a touch manipulation was detected on one of the GUI objects in the target web page within a prescribed period of time after a cancellation manipulation. Specifically, the correction management unit 15 determines, on the basis of the presence or absence of a report from the manipulation detection unit 16, whether a second touch manipulation was performed within a prescribed period of time after the cancellation manipulation for cancelling the first touch manipulation was performed. The “prescribed period of time” used herein is a period of time set in the timer in step S204.

When the second touch manipulation was performed on the target web page within a prescribed period of time after the cancellation manipulation was performed, the monitoring process related to the target web page proceeds to step S206. Specifically, when the manipulation detection unit 16 has reported the detection result related to the second touch manipulation to the correction management unit 15 before the timer set in step S204 is timed out, the correction management unit 15 subsequently executes step S206.

It is assumed for example that the target web page is web page P1 in example E1 illustrated in FIG. 2. It is also assumed that a second touch manipulation was performed within a prescribed period of time after the cancellation manipulation described in step S11. In such a case, the manipulation detection unit 16 detects the jump in step S12 by identifying object area G2. Then, the manipulation detection unit 16 reports to the correction management unit 15 the fact that a manipulation in the application software 12 has been detected and information representing object area G2.

Accordingly, in such a case, the correction management unit 15 recognizes on the basis of a report from the manipulation detection unit 16 that a specific manipulation sequence of “first touch manipulation, cancellation manipulation and second touch manipulation” was performed. However, there is a possibility that a second cancellation manipulation for cancelling the second touch manipulation will further be performed. In a case when a second cancellation manipulation has been performed, it is inappropriate to update the correction DB 14 on the basis of the above manipulation sequence including the second touch manipulation, which has been cancelled. Accordingly, the correction management unit 15 executes step S206 through s270, which will be explained later, in order to avoid inappropriate updates of the correction DB 14.

There is a case where a second touch manipulation is not performed on the target web page even when a prescribed period of time has elapsed after a cancellation manipulation for cancelling the first touch manipulation was performed. Specifically, there is a case in which the timer set in step S204 is timed out. In such a case, the monitoring process related to the target web page returns from step S205 to step S201. The reasons for this are as follows.

It is assumed for instance that a GUI object that is not the GUI object that the user intended to touch was identified as the target of the first touch manipulation. In such a case, at the moment when the user performed the first manipulation, the user had already determined which of the GUI objects to touch. Accordingly, it is estimated in this case that the period of time between the cancellation manipulation and the second touch manipulation is short.

From the opposite point of view, when a period of time is long between a cancellation manipulation and a second touch manipulation, the probability that “the user performed the second touch manipulation as a correction for the first touch manipulation” is low. In other words, when a period of time between a cancellation manipulation and a second touch manipulation is long, the probability that “the user performed the first touch manipulation and the second touch manipulation with different intentions” is high. Therefore, it is inappropriate to update the correction DB 14 when the period of time is long between a cancellation manipulation and a second touch manipulation. Accordingly, when the timer set in step S204 has been timed out, the monitoring process returns from step S205 to step S201.

Note that the correction management unit 15 may keep the process sleeping for the target web page during the period of time set in the timer in step S204. When the process has woken up due to time-out, the monitoring process returns from step S205 to step S201. When the process has been woken up in response to a report from the manipulation detection unit 16 before the time-out, the monitoring process proceeds from step S205 to step S206.

Meanwhile, when the correction management unit 15 has recognized, on the basis of a report from the manipulation detection unit 16, that a second touch manipulation was detected on one of the GUI objects in the target web page, the correction management unit 15 operates as follows in step S206. Note that because step S206 through step S207 are similar to step S202 through step S203, detailed explanations for such steps will be omitted.

In step S206, the correction management unit 15 starts the monitoring of the next web page. The “next web page” used herein is a web page newly displayed in the window by the application software 12 in response to a second touch manipulation. Accordingly, the web page being displayed in the window at the moment of step S206 is a “next web page” and not the “target web page”.

It is assumed for example that the target web page is web page P1 in example E1 illustrated in FIG. 2. It is also assumed that a second touch manipulation was performed within a prescribed period of time after the cancellation manipulation described in step S11 and the jump described in step S12 was executed in response to the second touch manipulation. In such a case, “next web page” in step S206 is web page P3.

Also, the correction management unit 15 sets the timer related to the target web page in step S206. The period of time set in the timer in step S206 may be equal to the period of time set in step S202 and/or step S204 or may be different. Also, the length of the period of time set in the timer may be a constant, may be a value that has been learned dynamically or may be a value specified by the user. For the sake of convenience in the explanations below, it is assumed that a prescribed period of time is set in the timer. The correction management unit 15 may keep the process asleep for the target web page during the period of time set in the timer.

Next, the correction management unit 15 determines in step S207 whether a cancellation manipulation was performed within a prescribed period of time. The “prescribed period of time” used herein is a period of time set in the timer in step S206. In other words, the correction management unit 15 determines whether a cancellation manipulation for cancelling the second touch manipulation was performed within a prescribed period of time after the second touch manipulation was performed.

When a cancellation manipulation has been performed on the next web page within a prescribed period of time after the second touch manipulation was performed on the target web page, the monitoring process related to the target web page returns from step S207 to step S201. At the moment when the monitoring process returned to step S201, the target web page is being displayed in a window of the application software 12 again.

When there is not a cancellation manipulation within a prescribed period of time after the second touch manipulation was performed on the target web page (i.e., when time-out has occurred), the correction management unit 15 performs a correction DB update process described in step S208. In other words, when confirming that a specific manipulation sequence of “a first touch manipulation, a cancellation manipulation and a second touch manipulation” has been performed in a short period of time, the correction management unit 15 executes a correction DB update process.

The correction DB update process will be explained later in detail by referring to FIG. 8 through FIG. 10. When the correction DB update process in step S208 has been terminated, the monitoring process, illustrated in FIG. 7, related to the target web page is also terminated. Note that the execution of the monitoring process related to the web page displayed in response to the second touch manipulation (i.e., “next web page” explained in relation to step S206) is continued.

It is assumed for example that the target web page is web page P1 in example E1 illustrated in FIG. 2 and that a cancellation manipulation was not performed within a prescribed period of time after the jump described in step S12. In such a case, the correction management unit 15 executes the correction DB update process described in step S208.

Specifically, the correction management unit 15 uses the information of the following four areas so as to execute the correction DB update process in accordance with the flowchart described in FIG. 8. As explained in relation to the detection of the first and second touch manipulations, the correction management unit 15 has stored information representing the following four areas in for example the memory 23.
Contact area C1 that was detected in step S101 illustrated in FIG. 6 in response to a first touch manipulation and that had its position corrected in step S103
Object area G1 identified by the manipulation detection unit 16 in response to a first touch manipulation
Contact area C2 that was detected in step S101 illustrated in FIG. 6 in response to a second touch manipulation and that had its position corrected in step S103
Object area G2 that was identified by the manipulation detection unit 16 in response to a second touch manipulation
   Note that a specific example of information representing each area may be a combination of the X and Y coordinates of the center point of the area, width of the area and the height of the area. Alternatively, an example of information representing each area may be a combination of the X and Y coordinates of the upper left point of the area and the X and Y coordinates of the lower right point of the area.

It is also possible for the correction management unit to monitor a manipulation sequence of “a first touch manipulation, a cancellation manipulation and a second touch manipulation” in accordance with a flowchart obtained by appropriately modifying the flowchart illustrated in FIG. 7 even when the application software 12 is not a web browser.

FIG. 8 illustrates a flowchart for a correction DB update process. In the explanations for FIG. 8, reference will be made to FIG. 9 and FIG. 10 on an as-needed basis. FIG. 9 explains the coordinate system and also explains a plurality of examples related to the arrangement of two GUI objects. FIG. 10 explains angle θ, which represents the direction in which a second touch manipulation was performed relative to a first touch manipulation.

Hereinafter, a contact area and an object area corresponding to a first touch manipulation are referred to as “first contact area” and “first object area”, respectively. Also, a contact area and an object area corresponding to a second touch manipulation are referred to as “second contact area” and “second object area”, respectively.

For the sake of convenience of explanation, it is assumed that first and second contact areas are areas expressed by conditions (7) and (8), respectively. Example E3 illustrated in FIG. 9 illustrates the X and Y coordinates of the four corners of a first contact area, the X axis and the Y axis. Note that the values such as Xₜ₀ in conditions (7) and (8) are values obtained by the correction management unit 15 performing correction on the basis of information in the current correction DB 14.

Xₜ₀≦X≦Xₜ₁ and Yₜ₀≦Y≦Yₜ₁ (7)

Xᵤ₀≦X≦Xᵤ₁ and Yᵤ₀≦Y≦Yᵤ₁ (8)

Also, for the sake of convenience of explanation, it is assumed that first and second object areas are areas expressed by conditions (9) and (10), respectively.

X₁₀≦X≦X₁₁ and Y₁₀≦Y≦Y₁₁ (9)

X₂₀≦X≦X₂₁ and Y₂₀≦Y≦Y₂₁ (10)

When the correction management unit 15 has detected a specific manipulation sequence of “a first touch manipulation, a cancellation manipulation and a second touch manipulation” as illustrated in FIG. 7, the correction management unit 15 starts the correction DB update process illustrated in FIG. 8. In the correction DB update process, the correction management unit 15 determines whether to update correction value ΔX and whether to update correction value ΔY, and operates in accordance with the determination.

First, in step S301, the correction management unit 15 determines whether the first contact area and the second contact area are close to each other. For example, the correction management unit 15 may make the determination on the basis of the overlapping between the first and second contact areas as below.
When at least part of the first contact area and at least part of the second contact area are overlapping (i.e., when condition (11) is met), the first and second contact areas are close to each other.

Xₜ₀≦Xᵤ₁ and Xₜ₁≧Xᵤ₀ and

Yₜ₀≦Yᵤ₁ and Yₜ₁≧Yᵤ₀ (11)
When the first and second contact areas are not overlapping at all (i.e., when condition (11) is not met and condition (12), which is a contraposition of condition (11), is met), first and second contact areas are far apart.

Xₜ₀>Xᵤ₁ and Xₜ₁<Xᵤ₀ and

Yₜ₀>Yᵤ₁ and Yₜ₁<Yᵤ₀ (12)

For example, in example E1 illustrated in FIG. 2, contact areas C1 and C2 are overlapping. Accordingly, the correction management unit 15 determines that “contact areas C1 and C2 are close to each other”. In example E2, contact areas C3 and C4 are not overlapping at all. Accordingly, the correction management unit 15 determines that “contact areas C3 and C4 are far apart”.

Alternatively, in step S301, the correction management unit 15 may make a determination on the basis of the overlapping between enlarged first and second contact areas instead of the overlapping between first and second contact areas themselves.

For example, it is assumed that an appropriate positive value for defining the margin in the X direction is w and an appropriate positive value for defining the margin in the Y direction is h. The union between a first margin area defined by width w and height h around the first contact area and the first contact area itself is the enlarged first contact area. Similarly, the union between a second margin area defined by width w and height h around the second contact area and the second contact area itself is the enlarged second contact area.

The correction management unit 15 may make the determination on the basis of the overlapping between the enlarged first and second contact areas, specifically in the following manner.
When at least part of the enlarged first contact area and at least part of the enlarged second contact area are overlapping (i.e., when condition (13) is met), the first and second contact areas are close to each other.

Xₜ₀−w≦Xᵤ₁+w and

Xₜ₁+wXᵤ₀−w and

Yₜ₀−h≦Yᵤ₁+h and

Yₜ₁+h≧Yᵤ₀−h (13)
When the first and second contact areas are not overlapping at all (i.e., when condition (13) is not met), the first and second contact areas are far apart.

Note that values w and h above may be constants and may be values defined on the basis of one or both of the first and second contact areas. For example, the product of the average value of the widths of the first and second contact areas (for example, 0.1 or other values) may be used as value w for defining the margin in the X direction. Value h may also be defined in a similar manner.

Alternatively, the correction management unit 15 may make the determination in step S301 on the basis of the distance between the point representing the first contact area and the point representing the second contact area. The point representing the first contact area may be for example the centroid of the first contact area. Similarly, the point representing the second contact area may be for example the centroid of the second contact area. Specifically, the correction management unit 15 may make the determination in the following manner by using threshold D.
When the distance between the centroids of the first and second contact areas is equal to or smaller than threshold D (i.e., when condition (14) is met), the first and second contact areas are close to each other

$$\begin{matrix}[ Expression 1 ] & \\ \sqrt{{( \frac{{X}_{u 0} + {X}_{u 1}}{2} - \frac{{X}_{t 0} + {X}_{t 1}}{2} )}^{2} + {( \frac{{Y}_{u 0} + {Y}_{u 1}}{2} - \frac{{Y}_{t 0} + {Y}_{t 1}}{2} )}^{2}} \leq D & ( 14 )\end{matrix}$$

When the distance between the centroids of the first and second contact areas is greater than threshold D (i.e., when condition (14) is not met), first and second contact areas are far apart.

Specifically, threshold D is a value based on one or both of the first and second contact areas (for example, the width, the height and the area, or a combination of two or more of them).

Alternatively, the correction management unit 15 may make a determination in step S301 on the basis of other factors, such as the area in which the first and second contact areas are overlapping. In any of these cases, the correction management unit 15 determines, in step S301, whether the first and second contact areas are close to each other according to a prescribed criterion.

When the first and second contact areas are far apart according to a prescribed criterion, the correction management unit 15 terminates the correction DB update process illustrated in FIG. 8 without updating correction value ΔX or correction value ΔY. For example, in example E2 illustrated in FIG. 2, because contact areas C3 and C4 are far apart, the correction management unit 15 does not correct correction value ΔX or correction value ΔY.

When the first and second contact areas are close to each other according to a prescribed criterion, the correction management unit 15 determines whether to update correction value ΔX on the basis of the direction of the second touch manipulation relative to the first touch manipulation and on the size of the second object area (for example, the width). Also, when the first and second contact areas are close to each other according to a prescribed criterion, the correction management unit 15 determines whether to update correction value ΔY on the basis of the direction of the second touch manipulation relative to the first touch manipulation and on the size of the second object area (for example, the height).

Specifically, when the correction management unit 15 has determined in step S301 that “the first and second contact areas are close to each other”, the correction management unit 15 calculates in step S302 the angle representing the direction of the second touch manipulation relative to the first touch manipulation. Specific definitions of the direction may include various definitions in accordance with embodiments. The direction is expressed by angle θ in FIG. 10. Angle θ is an example of an angle that represents “in what angle the touch manipulation was performed as correction”.

Explanations will now be given for angle θ by referring to FIG. 10. Angle θ is an angle within a scope between −90 degrees and 90 degrees with respect to the X axis.

FIG. 10 illustrates example E11 in which the absolute value |θ| of angle θ is close to zero degrees, example E12 in which the absolute value |θ| of angle θ is intermediate, and example E13 in which the absolute value |θ| of angle θ is close to 90 degrees. Note that “whether absolute value |θ| is close to zero degrees, intermediate, or close to 90 degrees” is defined by two appropriate two thresholds that are greater than zero degrees and smaller than 90 degrees. As an example, a definition in a case when the two thresholds are 20 degrees and 70 degrees is exemplified below.
When 0°≦|θ|<20° is satisfied, absolute value |θ| is close to zero degrees (i.e., angle θ represents a direction close to the X direction).
When 20°≦|θ|<70° is satisfied, absolute value |θ| is intermediate (i.e., angle θ represents a diagonal direction not close to the X direction or the Y direction).
When 70°<|θ|≦90° is satisfied, absolute value |θ| is close to 90 degrees (i.e., angle θ represents a direction close to the Y direction).

While the two thresholds may be selected appropriately in accordance with embodiments, the sum of the two thresholds is 90 degrees. Also, while absolute values |θ| are classified into three categories in the above example, absolute values |θ| may be classified into two categories depending upon embodiments. For example, definitions as follows may be employed. When the following definitions are employed, steps S308 and S309, which will be described later, are deleted from the flowchart illustrated in FIG. 8.
When 0°≦|θ|<45° is satisfied, absolute value |θ| is close to 0 degrees (i.e., angle θ represents a direction close to the X direction).
When 45°≦|θ|≦90° is satisfied, absolute value |θ| is close to 90 degrees (i.e., angle θ represents a direction close to the Y direction).

For the sake of convenience of explanation below, an area in which the first object area and the first contact area are overlapping is referred to as a “first overlapping area”. Also, an area in which the second object area and the second contact area are overlapping is referred to as a “second overlapping area”.

Angle θ is an angle formed by the horizontal directions (i.e., the X directions) and the line that connects the point representing a first overlapping area and the point representing a second overlapping area. For example, the point representing the first overlapping area may be the centroid of the first overlapping area and the point representing the second overlapping area may be the centroid of the second overlapping area.

In example E11, first and second object areas G51 and G52 are depicted by two white rectangles. Also, first and second contact areas C51 and C52 are depicted by two halftone-dotted rectangles. First overlapping area O1, in which first object area G51 and first contact area C51 are overlapping, is depicted by a rectangle with diagonal lines. Similarly, second overlapping area O2, in which second object area G52 and second contact area C52 are overlapping, is depicted by a rectangle with diagonal lines.

Angle θ in example E11 is an angle formed by the X axis and line D1 that connects the centroids of first and second overlapping areas O1 and O2.

The correction management unit 15 can calculate the X and Y coordinates of the centroid of first overlapping area O1 from the X and Y coordinates of the points of the four corners of first object area G51 and the X and Y coordinates of the points of the four corners of first contact area C51. The correction management unit 15 can calculate the X and Y coordinates of second overlapping area O2 from the points of the four corners of second object area G52 and the X and Y coordinates of the points of the four corners of second contact area C52

Accordingly, the correction management unit 15 can calculate angle θ by using an inverse trigonometric function from the X and Y coordinates of the centroid of first overlapping area O1 and the X and Y coordinates of the centroid of second overlapping area O2. Angle θ in example E11 represents a direction close to the X direction.

Also, example E12 depicts first and second object areas G53 and G54, first and second contact areas C53 and C54, and first and second overlapping areas O3 and O4. Angle θ in example E12 is an angle formed by the X axis and line D3 that connects the centroids of first and second overlapping areas O3 and O4.

Also in example E12, the correction management unit 15 can calculate angle θ by using a method similar to that used in example E11. Angle θ in example E12 is intermediate. In other words, angle θ represents a diagonal angle that is close to neither the X direction nor Y direction.

Also, example E13 depicts first and second object areas G55 and G56, first and second contact areas C55 and C56, and first and second overlapping areas O5 and O6. Angle θ in example E13 is an angle formed by the X axis and line D5 that connects the centroids of first and second overlapping areas O6 and O6.

Also in example E13, the correction management unit 15 can calculate angle θ by using a method similar to that used in example E11. Angle θ in example E13 represents a direction close to the Y direction.

As described above, in the present embodiment, the direction of a second touch manipulation relative to the first touch manipulation is determined on the basis of the first and second overlapping areas. In other words, the direction of the second touch manipulation relative to the first touch manipulation is determined on the basis of not only the first and second contact areas but also the first and second object areas. Determining the direction of a second touch manipulation relative to a first touch manipulation on the basis of the geometric relationship (positional relationship, specifically) between the first and second overlapping areas brings about the following advantages.

In some cases, a GUI object that is not the GUI object that the user intended to touch in a first touch manipulation and that is arranged close to the intended GUI object is identified as the target of the first touch manipulation. In such a case, the user will perform a cancellation manipulation and a second touch manipulation.

In such a case, from a certain point of view, the first overlapping area reflects “how the user's intention was missed”. Also, in this case, from a certain point of view, the second overlapping area reflects “how the user's original intention was correctly interpreted”.

Accordingly, the correction management unit 15 calculates angle θ on the basis of the first and second overlapping areas instead of calculating the angle only on the basis of the first and second contact areas, and thereby can recognize the direction of the second touch manipulation relative to the first touch manipulation more accurately.

However, in some embodiments, the correction management unit 15 may use, for example, an angle formed by the X axis and the line connecting the centroids of the first and second contact areas instead of angle θ.

FIG. 8 is explained again. The correction management unit 15 determines in step S303 “whether a direction represented by angle θ is close to horizontal, is close to vertical or is oblique, which is close to neither horizontal nor vertical” after calculating angle θ in step S302. For example, when the two thresholds are 20 degrees and 70 degrees as exemplified by referring to FIG. 10, the correction management unit 15 operates as below.

When 0°≦|θ|<20° is satisfied, the correction management unit 15 determines that “direction represented by angle θ is close to horizontal” and executes step S304 next.

When 70°<|θ|≦90° is satisfied, the correction management unit 15 determines that “direction represented by angle θ is close to vertical”, and executes step S306 next. When 20°≦|θ|≦70° is satisfied, the correction management unit 15 determines that “direction represented by angle θ is a diagonal direction”, and executes step S308 next.

In any of steps S304, S306 and S308, the correction management unit 15 determines whether to update the correction DB 14 on the basis of the size of the second object area. Now, examples E4 through E10 illustrated in FIG. 9 will be referred to in order to explain the reason why determination based on the size of a second object area is preferable. Examples E4 through E6 are examples in which updating the correction DB 14 is preferable and examples E7 through E10 are examples in which updating the correction DB 14 is not preferable.

Example E4 depicts first object area G31, second object area G32 and first contact area C31. The second contact area is omitted.

Example E5 depicts first object area G33, second object area G34 and first contact area C33. The second object area is omitted.

Example E6 depicts first object area G35, second object area G36, first contact area C35 and second contact area C36.

Example E7 depicts first object area G37, second object area G38, first contact area C37 and second contact area C38.

Example E8 depicts first object area G39, second object area G40 and first contact area C39. The second contact area is omitted.

Example E9 depicts first object area G41, second object area G42 and first contact area C41. The second contact area is omitted.

Example E10 depicts first object area G43, second object area G44 and first contact area C43. The second contact area is omitted.

Examples E4 and E8 are similar to each other in that the second object area exists in the horizontal direction with respect to the first object area. However, examples E4 and E8 are different from each other in the relative size of the second object area with respect to the area touched by the user's finger.

Specifically, in example E4, the width of second object area G32 is smaller than the width of the area touched by the user's finger (for example, the width of first contact area C31). By contrast, in example E8, the width of second object area G40 is great than the width of the area touched by the user's finger (for example, the width of first contact area C39). In other words, object area G40 is sufficiently great in the horizontal directions with respect to the user's finger.

Accordingly, when the user originally has an intention to touch object area G40, the user can easily touch an area that is overlapping object area G40 and that is not overlapping object area G39. In other words, when the user originally has an intention to touch object area G40, a probability that the user will touch a misleading area such as contact area C39 is low. Accordingly, even when a specific manipulation sequence of “a first touch manipulation, a cancellation manipulation and a second touch manipulation” has been detected and first contact area C39 and a second contact area (not illustrated) are close to each other, it is not desirable that the correction DB 14 be updated in example E8.

In example E4, with respect to the user's finger, object area G32 is small in the horizontal directions. Accordingly, in example E4, even when the user has an intention to touch object area G32, the contact area is not entirely included in object area G32. As a result of this, a probability that the user will touch a misleading area such as contact area C31 (i.e., an area that is partially overlapping object area G31, which the user does not have an intention to touch) is sufficiently high. Accordingly, when a specific manipulation sequence of “a first touch manipulation, a cancellation manipulation and a second touch manipulation” has been detected and first contact area C31 and the second contact area (not illustrated) are close to each other, it is desirable that correction DB 14 be updated in example E4.

Examples E5 and E9 are similar to each other in that the second object area exists in the horizontal direction with respect to the first object area. However, examples E5 and E9 are different from each other in the relative size of the second object area with respect to the area touched by the user's finger.

Specifically, in example E5, the height of second object area G34 is smaller than the height of the area touched by the user's finger (height of first contact area C33 for example). By contrast, in example E9, the height of second object area G42 is greater than the height of the area touched by the user's finger (height of first contact area C41 for example). In other words, with respect to the user's finger, object area G42 is sufficiently large in the horizontal directions.

Accordingly, when the user originally has an intention to touch object area G42, the user can easily touch an area that is overlapping object area G42 and that is not overlapping object area G41. In other words, when the user originally has an intention to touch object area G42, a probability that the user will touch a misleading area such as contact area C41 is low. Accordingly, even when a specific manipulation sequence of “a first touch manipulation, a cancellation manipulation and a second touch manipulation” has been detected and first contact area C41 and the second contact area (not illustrated) are close to each other, it is not desirable that the correction DB 14 be updated in example E9.

In example E5, with respect to the user's finger, object area G34 is small in the vertical directions. Accordingly, in example E5, even when the user has an intention to touch object area G34, the contact area is not entirely included in object area G34. As a result of this, a probability that the user will touch a misleading area such as contact area C33 (i.e., an area that is partially overlapping object area G33, which the user does not have an intention to touch) is sufficiently high. Accordingly, when a specific manipulation sequence of “a first touch manipulation, a cancellation manipulation and a second touch manipulation” has been detected and first contact area C33 and the second contact area (not illustrated) are close to each other, it is desirable that correction DB 14 be updated in example E5.

Examples E6, E7 and E10 are similar to each other in that the second object area exists in the diagonal direction with respect to the first object area. Also, examples E6 and E7 are similar to each other in that the size of the second object area is relatively small with respect to the area touched by the user's finger. Example E10 by contrast is different from examples E6 and E7 in that the size of the second object area is relatively large with respect to the area touched by the user's finger.

Specifically, in example E6, the width of second object area G36 is smaller than the width of the area touched by the user's finger (the width of one of contact areas C35 and C36 or the average value of their widths for example). Also, in example E6, the height of second object area G36 is smaller than the height of the area touched by the user's finger (height of one of contact areas C35 and C36 or the average value of their heights for example). Similarly, second object area G38 has a width and a height that are smaller than those of the area touched by the user's finger also in example E7.

By contrast, in example E10, the width of second object area G44 is greater than the width of the area touched by the user's finger (width of contact area C43 for example). Also, in example E10, the height of second object area G44 is greater than the height of the area touched by the user's finger (height of first contact area C43 for example). In other words, with respect to the user's finger, object area G44 is sufficiently large in the horizontal directions and the vertical directions.

Accordingly, when the user originally has an intention to touch object area G44, the user can easily touch an area that is overlapping object area G44 and that is not overlapping object area G43. In other words, when the user originally has an intention to touch object area G44, a probability that the user will touch a misleading area such as contact area C43 is low. Accordingly, even when a specific manipulation sequence of “a first touch manipulation, a cancellation manipulation and a second touch manipulation” has been detected and first contact area C43 and a second contact area (not illustrated) are close to each other, it is not desirable that the correction DB 14 be updated in example E10.

In example E6, with respect to the user's finger, object area G36 is small in the horizontal and vertical directions. Accordingly, in example E6, even when the user has an intention to touch object area G36, the contact area is not entirely included in object area G36. As a result of this, a probability that the user will touch a misleading area such as contact area C35 (i.e., an area that is partially overlapping object area G35, which the user does not have an intention to touch) is sufficiently high. Also, in example E6, first and second contact areas C35 and C36 are close to each other. Accordingly, when a specific manipulation sequence of “a first touch manipulation, a cancellation manipulation and a second touch manipulation” has been detected, it is desirable that the correction DB 14 be updated in example E6.

In example E7, with respect to the user's finger, object area G38 is small in the horizontal and vertical directions. Accordingly, even when the user has an intention to touch object area G38, the contact area is not entirely included in object area G38. However, when first and second contact areas C37 and C38 are apart as in example E7, the probability that “the user having an intention to touch object area G38 actually touched first contact area C37 in the first touch manipulation” is low. Accordingly, it is desirable that the correction DB 14 not be updated in example E7. Accordingly, in the present embodiment, in step S301 illustrated in FIG. 8, the correction management unit 15 determines that “first and second contact areas C37 and C38 are apart more than a prescribed criterion” and thus the correction DB 14 is not updated in example E7.

As is understood from the above explanations regarding FIG. 9, it is preferable that the determination of whether to update the correction DB 14 be based on the size of the second object area instead of the size of the first object area.

Again FIG. 8 is explained. After step S303, the correction management unit 15 estimates “whether the reason for performing the cancellation manipulation and the second touch manipulation is that a GUI object that the user did not have an intention to touch in the first touch manipulation was identified as the target of the first touch manipulation”. Then, in accordance with the result of the estimation, the correction management unit 15 determines whether to update the correction DB 14. As is understood from examples E4 through E10 illustrated in FIG. 9, it is beneficial to use the size of the second object area for this estimation.

Specifically, the correction management unit 15 determines, in step S304, whether the width of the second object area is small (i.e., whether the width of the GUI object touched at the second time is small) on the basis of the width of the contact area.

When for example condition (15) is met, the correction management unit 15 may determine that “the width of the second object area is small”. In other words, when condition (15) is not met, the correction management unit 15 may determine that “the width of the second object area is great”. Condition (15) is a condition wherein “the width of the second object area is equal to or smaller than the width of the first contact area and is equal to or smaller than the width of the second contact area”.

Xₜ₁−Xₜ₀≧X₂₁−X₂₀ and

Xᵤ₁−Xᵤ₀≧X₂₁−X₂₀ (15)

Alternatively, one of conditions (16) through (19) may be used instead of condition (15). Because it is assumed that the first and second contact areas have roughly the same widths, conditions (16) through (19) are met to roughly the same degree as the condition (15).

Xᵤ₁−Xᵤ₀≧X₂₁−X₂₀ (16)

{(Xₜ₁−Xₜ₀)+(Xᵤ₁−Xᵤ₀)}/2≧X₂₁−X₂₀ (17)

Xₜ₁−Xₜ₀≧X₂₁−X₂₀ (18)

Xₜ₁−Xₜ₀X₂₁−X₂₀ or

Xᵤ₁−Xᵤ₀≧X₂₁−X₂₀ (19)

It is when the direction represented by angle θ is close to horizontal (i.e., the X direction) that step S304 is executed. A case when the direction represented by angle θ is close to the X direction is, in other words, a case when an erroneous manipulation has been detected in a direction close to the X direction.

As is understood from examples E4 and E8 illustrated in FIG. 9, when the width of the second object area is great (in example E8 for example), the probability that “an erroneous manipulation was performed in a direction close to the X direction” is low. In other words, when the width of the second object area is great, it is estimated that “the user performed the first and second touch manipulations, having different intentions”.

Accordingly, when the width of the second object area is great, it is not desirable that the correction DB 14 be updated. Thus, when the correction management unit 15 has determined in step S304 that “the width of the second object area is great”, the correction management unit 15 terminates the correction DB update process illustrated in FIG. 8 without updating the correction DB 14.

When by contrast the width of the second object area is small (in example E4 for example), the probability that “an erroneous manipulation was performed in a direction close to the X direction” is high. In other words, when the width of the second object area is small, it is estimated that “the user performed the first and second touch manipulations, having the same intentions”.

Accordingly, when the width of the second object area is small, it is desirable that correction value ΔX, which is related to the X direction (i.e., a direction close to the direction in which the erroneous manipulation was performed), be updated. Accordingly, when the correction management unit 15 has determined in step S304 that “the width of the second object area is small”, the correction management unit 15 updates correction value ΔX in step S305.

However, the correction management unit 15 does not update correction value ΔY in step S305, because the Y direction is far from the direction of the erroneous manipulation (i.e., the direction represented by angle θ). In other words, the correction management unit 15 does not update correction value ΔY in step S305 because there is no evidence that is reliable enough to estimate that “current correction value ΔY is inappropriate”.

Specific methods of updating correction value ΔX in step S305 include many variations from two points of view. The first point of view is a data format of the correction DB 14 and the second point of view is weighting.

As exemplified in FIG. 5, the correction DB 14 may have various data formats. When the correction DB 14a is used, there is only one correction value ΔX and accordingly the correction management unit 15 updates this correction value ΔX. However, as in the cases of the correction DBs 14b through 14e, there is a case where the correction DB 14 has a plurality of entries that correspond to a plurality of conditions. In such a case, the correction management unit 15 updates correction value ΔX that corresponds to a condition met at the time of the first touch manipulation among a plurality of correction conditions.

As was explained by referring to FIG. 6 and FIG. 7, the memory 23 has stored information that directly or indirectly represents the position of an area detected by the position detection unit 13 in response to a first touch manipulation, together with information representing a first object area.

Accordingly, the correction management unit 15 can recognize the X and Y coordinates of the position of an area detected by the position detection unit 13 in response to a first touch manipulation by using information stored in the memory 23 regarding the first contact area.

In other words, the correction management unit 15 can recognize X and Y coordinates (Xt,Yt) that are expressed by numerical expressions (20) and (21) by using information stored in the memory 23.

Xt=(Xₜ₀+Xₜ₁)/2−ΔX (20)

Yt=(Yₜ₀+Yₜ₁)/2−ΔY (21)

Correction value ΔX in numerical expression (20) is a correction value used by the correction management unit 15 when a first touch manipulation was performed and is also a value that the correction management unit 15 is to update currently. Also, correction value ΔY in numerical expression (21) is a correction value used by the correction management unit 15 when a first touch manipulation was performed. However, as described above, correction value ΔY is not updated in step S305.

When for example the correction DB 14b or 14e is used, the correction management unit 15 updates correction value ΔX of an entry that corresponds to a block to which X and Y coordinates (Xt,Yt) recognized in the above manner belong.

When the correction DB 14c is used, the correction management unit 15 uses X and Y coordinates (Xt,Yt) that were recognized in the above manner so as to inquire of the manipulation detection unit 16. Then, the correction management unit 15 updates correction value ΔX of an entry that corresponds to the combination between recognized X and Y coordinates (Xt,Yt) and the result of the inquiry.

When the correction DB 14d is used, the correction management unit 15 updates correction value ΔX of an entry that corresponds to the application software 12 on which the first touch manipulation was performed.

Note that the correction management unit 15 can also recognize the X and Y coordinates of the position of an area detected by the position detection unit 13 in response to a second touch manipulation by using information stored in the memory 23 regarding the second contact area. In other words, the correction management unit 15 can recognize X and Y coordinates (Xu,Yu) of numerical expressions (22) and (23). Correction value ΔX and correction value ΔY in numerical expressions (22) and (23) are correction values used by the correction management unit 15 when the second touch manipulation was performed.

Xu=(Xᵤ₀+Xᵤ₁)/2−ΔX (22)

Yu=(Yᵤ₀+Yᵤ₁)/2−ΔY (23)

Next, the above two points of view will be explained.

Difference dX, which is a difference between the position of the second contact area in the X direction and the position of the first contact area in the X direction, is expressed by numerical expression (24). Difference dX may be calculated by numerical expression (25).

dX=Xu−Xt (24)

dX=(Xᵤ₀+Xᵤ₁)/2−(Xₜ₀+Xₜ₁)/2 (25)

When correction value ΔX and correction value ΔY are defined in accordance with positional conditions as in the cases of correction DBs 14b, 14c and 14e, numerical expressions (20) and (22) do not always have the same correction value ΔX. Similarly, numerical expressions (21) and (23) do not always have the same correction value ΔY.

Therefore, in some cases, difference dX calculated by numerical expression (25) is not completely identical to difference dX of numerical expression (24). In other words, in some cases, difference dX calculated by numerical expression (25) is an approximate value of difference dX of numerical expression (24). However, because the first and second contact areas are close to each other, numerical expression (24) is well approximated by numerical expression (25). Accordingly, the correction management unit 15 may calculate difference dX in accordance with numerical expression (24) and may also calculate difference dX in accordance with numerical expression (25).

Specifically, the correction management unit 15 may update correction value ΔX as in numerical expression (26).

In numerical expression (26), “ΔX” at the right-hand side represents current correction value ΔX and “ΔX” at the left-hand side represents new correction value ΔX after being updated.

ΔX=ΔX+dX (26)

The correction management unit 15 may use positive coefficient α in order to update correction value ΔX in accordance with numerical expression (27). In numerical expression (27), “ΔX” at the right-hand side represents current correction value ΔX and “ΔX” at the left-hand side represents new correction value ΔX after being updated.

ΔX=ΔX+α·dX (27)

Coefficient α may be a constant. Coefficient α may be a value dependent upon difference dX. For example, coefficient α that monotonically decreases with respect to difference dX may be used. When the correction DB 14 that includes a counter such as the correction DB 14e is used, coefficient α may be a value dependent upon the value of a counter (for example, a value that monotonically decreases with respect to the value of a counter).

Note that, as explained by referring to FIG. 5, there may be a first counter for correction value ΔX and a second counter for correction value ΔY. In such a case, coefficient α may be a value dependent upon the value of the first counter.

When the correction DB 14 that includes a counter is used, the correction management unit 15 increments by one the value of the counter of an entry that includes update-target correction value ΔX in step S305. The initial value of the counter is zero.

A case when coefficient α is one corresponds to numerical expression (26). In a case when coefficient α is less than one, correction value ΔX is expected to gradually become closer to the optimum value. When coefficient α is greater than one, correction value ΔX is expected to converge to the optimum value while fluctuating.

As described above, there can be various specific methods for updating correction value ΔX in step S305. It is also possible to employ a configuration in which the correction management unit 15 updates correction value ΔX in accordance with a numerical expression that is not numerical expression (26) or (27).

The correction management unit 15 determines how much to update correction value ΔX on the basis of the position of the second contact area in the X direction. After the update of correction value ΔX in step S305, the correction management unit 15 terminates the correction DB update process illustrated in FIG. 8.

The correction management unit 15 determines whether the height of the second object area is small with respect to the height of a contact area (i.e., whether the height of the GUI object touched the second time is small).

When for example condition (28) is met, the correction management unit 15 may determine that “the height of the second object area is small”. In other words, when condition (28) is not met, the correction management unit 15 may determine that “the height of the second object area is great”. Condition (28) is a condition wherein “the height of the second object area is equal to or greater than the height of the first contact area and is equal to or smaller than the height of the second contact area”.

Yₜ₁−Yₜ₀≧Y₂₁−Y₂₀ and

Yᵤ₁−Yᵤ₀≧Y₂₁−Y₂₀ (28)

Alternatively, one of conditions (29) through (32) may be used instead of condition (28). Because it is assumed that the first and second contact areas have roughly the same heights, conditions (29) through (32) are met to roughly the same degree as condition (28).

Yᵤ₁−Yᵤ₀≧Y₂₁−Y₂₀ (29)

{(Yₜ₁−Yₜ₀)+(Yᵤ₁−Yᵤ₀)}/2≧Y₂₁−Y₂₀ (30)

Yₜ₁−Yₜ₀≧Y₂₁−Y₂₀ (31)

Yₜ₁−Yₜ₀≧Y₂₁−Y₂₀ or

Yᵤ₁−Yᵤ₀≧Y₂₁−Y₂₀ (32)

It is when the direction represented by angle θ is close to vertical (i.e., the Y direction) that step S306 is executed. A case when the direction represented by angle θ is close to the Y direction is, in other words, a case when an erroneous manipulation has been detected in a direction close to the Y direction.

As is understood from examples E5 and E9 illustrated in FIG. 9, when the height of the second object area is great (in example E9 for example), the probability that “an erroneous manipulation was performed in a direction close to the Y direction” is low. In other words, when the height of the second object area is great, it is estimated that “the user performed the first and second touch manipulations having different intentions”.

Accordingly, when the height of the second object area is great, it is not desirable that the correction DB 14 be updated. Accordingly, when the correction management unit 15 has determined that “the height of the second object area is great” in step S306, the correction management unit 15 terminates the correction DB update process illustrated in FIG. 8 without updating the correction DB 14.

When by contrast the height of the second object area is small (in example E5 for example), the probability that “an erroneous manipulation was performed in a direction close to the Y direction” is high. In other words, when the height of the second object area is small, it is estimated that “the user performed the first and second touch manipulations having the same intentions”.

Accordingly, when the height of the second object area is small, it is desirable that correction value ΔY, which is related to the Y direction, be updated (i.e., a direction close to the direction in which the erroneous manipulation was performed). Accordingly, when the correction management unit 15 has determined in step S306 that “the height of the second object area is small”, the correction management unit 15 updates correction value ΔY in step S307.

However, the correction management unit 15 does not update correction value ΔX in step S307. This is because the X direction is far from the direction of the erroneous manipulation (i.e., the direction represented by angle θ). In other words, the correction management unit 15 does not update correction value ΔX in step S307 because there is no evidence that is reliable enough to estimate that “current correction value ΔX is inappropriate”.

Specific methods of updating correction value ΔY in step S307 include many variations from two points of view. The first point of view is a data format of the correction DB 14 and the second point of view is weighting.

The first point of view is as explained by referring to step S305. The correction management unit 15 identifies correction value ΔY that is the update target by using an appropriate method in accordance with the data format of the correction DB 14. In other words, the correction management unit 15 identifies an entry including correction value ΔY that is the update target.

Explanations will be given for the second point of view below.

Difference dY between the position of the second contact area in the Y direction and the position of the first contact area in the Y direction is as expressed by numerical expression (33). Difference dY may also be calculated by numerical expression (34). Because numerical expressions (33) and (34) are similar to numerical expressions (24) and (25), detailed explanations thereof will be omitted.

dY=Yu−Yt (33)

dY=(Yᵤ₀+Yᵤ₁)/2−(Yₜ₀+Yₜ₁)/2 (34)

Specifically, the correction management unit 15 may update correction value ΔY as in numerical expression (35). In numerical expression (35), “ΔY” at the right-hand side represents current correction value ΔY and “ΔY” at the left-hand side represents new correction value ΔY after being updated.

ΔY=ΔY+dY (35)

The correction management unit 15 may use positive coefficient β in order to update correction value ΔY in accordance with numerical expression (36). Similarly to coefficient α, coefficient β may be smaller than one or may be greater than one. In numerical expression (36), “ΔY” at the right-hand side represents current correction value ΔY and “ΔY” at the left-hand side represents new correction value ΔY after being updated.

ΔY=ΔY+β·dY (36)

Coefficient β may be a constant. For example coefficients α and β may be the same constant. Coefficient β may be a value dependent upon difference dY. For example, coefficient β that monotonically decreases with respect to difference dY may be used. When the correction DB 14 that includes a counter such as the correction DB 14e is used, coefficient β may be a value dependent upon the value of a counter (for example, a value that monotonically decreases with respect to the value of a counter).

Note that, as explained by referring to FIG. 5, there may be a first counter for correction value ΔX and a second counter for correction value ΔY. In such a case, coefficient 13 may be a value dependent upon the value of the second counter.

When the correction DB 14 that includes a counter is used, the correction management unit 15 increments by one the value of the counter of an entry that includes update-target correction value ΔY in step S307. The initial value of the counter is zero.

As described above, there can be various specific methods for updating correction value ΔY in step S307. It is also possible to employ a configuration in which the correction management unit 15 updates correction value ΔY in accordance with an numerical expression that are not numerical expression (35) or (36).

In any of these cases, the correction management unit 15 determines how much to update correction value ΔY on the basis of the position of the second contact area in the Y direction. After the update of correction value ΔY in step S307, the correction management unit 15 terminates the correction DB update process illustrated in FIG. 8.

The correction management unit 15 determines, in step S308, whether the width and the height of the second object area are small with respect to the width and the height of a contact area (i.e., whether the width and height of the GUI object touched at the second time are small). Specifically, similarly to step S304, the correction management unit 15 determines whether the width of the second contact area is small. Also, similarly to step S306, the correction management unit 15 determines whether the height of the second object area is small.

It is when the direction represented by angle θ is close to neither the X direction nor the Y direction that step S308 is executed. A case when the direction represented by angle θ is close to neither the X direction or the Y direction is, in other words, a case when an erroneous manipulation has been detected in a diagonal direction (i.e., a direction for which ignoring one of the X and Y components is inappropriate). In such a case, it is desirable that both the X direction and Y direction be considered.

As is understood from examples E6 and E10 illustrated in FIG. 9, when at least one of the height and width of the second object area is great (in example E10 for example), the probability that “an erroneous manipulation was performed in a diagonal direction” is low. In other words, when at least one of the height and width of the second object area is great, it is estimated that “the user performed the first and second touch manipulations, having different intentions”.

Accordingly, at least one of the height and width of the second object area is great, it is not desirable that the correction DB 14 be updated. Accordingly, when the correction management unit 15 has determined that “at least the height and width of the second object area is great” in step S308, the correction management unit 15 terminates the correction DB update process illustrated in FIG. 8 without updating the correction DB 14.

When by contrast both the width and height of the second object area are small (in example E6 for example), the probability that “an erroneous manipulation was performed in a diagonal direction” is high. In other words, when both of the width and height of the second object area are small, it is estimated that “the user performed the first and second touch manipulations, having the same intentions”.

Accordingly, when the width and height of the second object area are small, it is desirable that both correction value ΔX and correction value ΔY be updated. Accordingly, when the correction management unit 15 has determined in step S308 that “both the width and height of the second object area are small”, the correction management unit 15 updates both correction value ΔX and correction value ΔY in step S309. The update of correction value ΔX is similar to step S305, and the update of correction value ΔY is similar to step S307. After updating correction value ΔX and correction value ΔY in step S309, the correction management unit 15 terminates the correction DB update process illustrated in FIG. 8.

Incidentally, the present invention is not limited to the above embodiments. While explanations have been given for some variations in the above explanations, the above embodiments allow further variations from for example the points of view below. The above and following variations can be combined arbitrarily as long as such a combination causes a contradiction.

Some of the processes in the above embodiments include comparison with thresholds. Comparison with thresholds may be a process of determining “whether a value that is a comparison target is greater than a threshold” or may be a process of determining “whether a value that is a comparison target is equal to or greater than a threshold”. In the exemplified inequalities, “≦” can be replaced with “<” and also “<” can be replaced with “≦”.

Also, while thresholds for various purposes were exemplified in the above explanations, specific values for the respective thresholds may be determined arbitrarily and appropriately.

In the above explanations, examples in which each area is expressed by a bounding box have been used mainly. However, areas can be expressed as areas having a shape that is not rectangular.

When areas that are not rectangular in shape are used, an arbitrary collision determination algorithm that is related to collisions between areas can be used for detecting overlapping between areas. In the field of computer graphics for example, various collision determination algorithms are known.

For example, it is also possible to employ a configuration in which the correction management unit 15 determine whether the first and second contact areas are overlapping in accordance with an appropriate collision determination algorithm. The correction management unit 15 may use an appropriate overlapping detection algorithm for identifying an overlapping area in which a contact area and an object area are overlapping. It is also possible to use an appropriate algorithm for obtaining the centroid of an area that is not rectangular.

Also, hardware for implementing the terminal device 10 second identifier FIG. 1 is not limited to the computer 20 as illustrated in FIG. 4, which is for general purposes. It is also possible to use a dedicated hardware circuit such as an ASIC (Application-Specific Integrated Circuit) and/or a reconfigurable circuit such as an FPGA (Field Programmable Gate Array) can be used instead of the CPU 21, which is for a general purpose. As a matter of course, a dedicated hardware circuit and/or reconfigurable circuit can be used together with the CPU 21, which is for a general purpose.

Even when the computer 20 is used, the embodiments may have variations about in which of various layers such as firmware, OS, device driver, etc. each of the correction management unit 15, the correction management unit 15 and the manipulation detection unit 16 is to be implemented. In the above embodiments, the correction management unit 15 conducts both correction of coordinates and update of correction information, however, in some embodiments, separate modules may conduct correction of coordinates and update of correction information.

Next, explanations will be given for common points of the respective embodiments that can be modified in various ways as described above.

As exemplified in step S301 illustrated in FIG. 8, when the first and second contact areas are far apart according to a prescribed criterion, the correction DB 14 is not updated. When the first and second contact areas are close to each other according to a prescribed criterion, the correction management unit 15 determines “whether to update the correction DB 14” on the basis of the direction of the second touch manipulation relative to the first touch manipulation and the size of the second object area. The behaviors as described above is based on the following considerations.

Reasons for the execution of a specific manipulation sequence of “a first touch manipulation, a cancellation manipulation for cancelling the first touch manipulation, and a second touch manipulation” include at least the two following reasons.

The first reason is that “a different GUI object arranged close to a GUI object that the user intended to touch in a first touch manipulation was identified as the target of the first touch manipulation”. In such a case, the application software 12 behaves against the intention of the user.

Then, the user performs a cancellation manipulation for cancelling the first touch manipulation, and thereafter performs the second touch manipulation in order to realize the original intention. For example, example E1 in FIG. 2 is an example in which a cancellation manipulation and a second touch manipulation are performed for the first reason”.

The second reason is that “the actual behavior of the application software 12 did not satisfy the user”. For example, example E2 illustrated in FIG. 2 is an example in which a cancellation manipulation and a second touch manipulation are performed for the second reason.

In some cases, a GUI object itself that the user intended to touch in a first touch manipulation is identified as the target of the first touch manipulation. In such a case, the application software 12 behaves in accordance with instructions that the user gave to the application software 12 in the first touch manipulation (in step S20 in example E2 for example). However, there is a possibility that the actual behavior of the application software 12 does not satisfy the user. For example, in example E2, there is a possibility that the user will glance at web page P4 and feel that “this web page is not what I expected”.

As described above, in some cases, actual behaviors of the application software 12 are not satisfactory. In such a case, the user may in some cases perform a cancellation manipulation for cancelling a first touch manipulation and thereafter perform a second touch manipulation as an attempt to obtain a result that is more satisfactory.

Incidentally, when a cancellation manipulation and a second touch manipulation were performed for the first reason, the usability is expected to increase by updating correction value ΔX and/or correction value ΔY.

When however a cancellation manipulation and a second touch manipulation were performed for the second reason, there is not an evident that is reliable enough to estimate that “current correction value ΔX and correction value ΔY are inappropriate”. Accordingly, in this case, it is desirable that correction value ΔX or correction value ΔY not be updated. Because when the correction management unit 15 updates correction value ΔX and/or correction value ΔY, there is a possibility that such excessive (or inappropriate) updates will degrade the usability.

Then, the correction management unit 15 estimates which of the first and second reasons caused the cancellation manipulation and the second touch manipulation. Thereafter, the correction management unit 15 determines, on the basis of the estimation, whether it is preferable that correction value

ΔX be updated and whether it is preferable that correction value ΔY be updated. For example, it is possible to conduct the estimation as described in steps S301 through S304, S306 and S308 illustrated in FIG. 8.

As in example E2 illustrated in FIG. 2 and example E7 illustrated in FIG. 9 for example, when first and second contact areas are far apart according to a prescribed criterion, the probability that “the cancellation manipulation and the second touch manipulation were performed for the first reason” is low. In other words, when a first and second contact areas are far apart according to a prescribed criterion, the probability that “the cancellation manipulation and the second touch manipulation were performed for the second reason” is high. Accordingly, in such a case, the correction management unit 15 updates neither correction value ΔX nor correction value ΔY as described above.

When first and second contact areas are close to each other according to a prescribed criterion, the possibility that “the cancellation manipulation and the second touch manipulation were performed for the first reason” exists. The possibility that “the cancellation manipulation and the second touch manipulation were performed for the second reason” also exists. Accordingly, when first and second contact areas are close to each other according to a prescribed criterion, the correction management unit 15 determines which of the two possibilities are more likely.

For this determination, the direction of the second touch manipulation relative to the first touch manipulation and the size of the second object area are used as described above. In the example illustrated in FIG. 8 for example, the direction of the second touch manipulation relative to the first touch manipulation is determined in steps S302 through S303, and the size of the second object area is determined in steps S304, S306 and S308. The direction of the second touch manipulation relative to the first touch manipulation is specifically determined on the basis of the geometric relationships between the first object area, the second object area, the first contact area and the second contact area.

For the sake of convenience of explanation below, the condition for determining “whether the second touch manipulation was performed relative to the first touch manipulation in a direction close to the X direction” is referred to as “horizontal arrangement condition”. Also, the condition for determining “whether the second touch manipulation was performed relative to the first touch manipulation in a direction close to the Y direction” is referred to as “vertical arrangement condition”.

The horizontal arrangement condition and the vertical arrangement condition are exclusive. The horizontal arrangement condition and the vertical arrangement condition may be defined appropriately in accordance with embodiments.

In some embodiments, the horizontal arrangement condition and the vertical arrangement condition may be defined in such a manner that there are three cases, specifically, a case where the horizontal arrangement condition is met, the vertical arrangement condition is met and neither of them is met. The example illustrated in FIG. 8, where two thresholds (for example 20 degrees and 70 degrees) relative to the absolute value |θ| of angle θ are used, is an example in which three cases exist as described above.

In some embodiments, it is possible to define the horizontal arrangement condition and the vertical arrangement condition in such a manner that only the two cases, i.e., the case where the horizontal arrangement condition is met and a case where the vertical arrangement condition is met, exist. For example, it is possible to classify the absolute value |θ| of angle θ into two by using only one threshold (45 degrees for example) as exemplified as the variation example in FIG. 8.

For the sake of convenience of explanation below, a case where “first and second contact areas are close to each other according to a prescribed criterion and first and second object areas and the first and second contact areas meet the horizontal arrangement condition” is referred to as a “first case”. A case where “first and second contact areas are close to each other according to a prescribed criterion and first and second object areas and the first and second contact areas meet the vertical arrangement condition” is referred to as a “second case”.

Also, a case when “first and second contact areas are close to each other according to a prescribed criterion and first and second object areas and the first and second contact areas meet neither the horizontal arrangement condition nor the vertical arrangement condition” is referred to as a “third case”. As described above, whether the third case exists depends upon the definitions of the horizontal arrangement condition and the vertical arrangement condition.

In the first case, the correction management unit 15 determines whether to update the correction value ΔX on the basis of the width of the second object area, and does not update the correction value ΔY. Specifically, when the width of the second object area is equal to or smaller than a first threshold that is determined in accordance with width(s) of one or both of the first and second contact areas, the correction management unit 15 updates the correction value ΔX. However, when the width of the second object area is greater than the first threshold, the correction management unit 15 does not update the correction value ΔX.

An specific example of a first case as described above is exemplified in steps S304 through S305 illustrated in FIG. 8. Also, the above first threshold may be for example arbitrary one of the following values or may be other different values that are appropriate.
Minimum value between the widths of the first and second contact areas (corresponding to numerical expression (15)
Product of the above minimum value and a prescribed coefficient close to 1 (for example a coefficient that is about 0.9 through 1.1)
Width of a second contact area (corresponding to numerical expression (16))
Product of the width of the second contact area and a prescribed coefficient close to 1
Average value of the widths of the first and second contact areas (corresponding to numerical expression (17))
Product of the above average value and a prescribed coefficient close to 1
Width of the first contact area (corresponding to numerical expression (18))
Maximum value between the widths of the first and second contact areas (corresponding to numerical expression (19))
Product of the above maximum value and a prescribed coefficient close to 1

In the second case, the correction management unit 15 determines whether to update the correction value ΔY, on the basis of the height of the second object area, and does not update the correction value ΔX. Specifically, when the height of the second object area is equal to or smaller than a second threshold that is determined in accordance with height(s) of one or both of the first and second contact areas, the correction management unit 15 updates the correction value ΔY. However, when the height of the second object area is greater than the second threshold, the correction management unit 15 does not update the correction value ΔY.

A specific example of a second case as described above is exemplified in steps S306 through S307 illustrated in FIG. 8. Also, the above second threshold may be for example arbitrary one of the following values or may be other values that are appropriate.
Minimum value between the heights of the first and second contact areas (corresponding to numerical expression (28)
Product of the above minimum value and a prescribed coefficient close to 1 (for example a coefficient that is about 0.9 through 1.1)
Height of a second contact area (corresponding to numerical expression (29))
Product of the height of the second contact area and a prescribed coefficient close to 1
Average value of the heights of the first and second contact areas (corresponding to numerical expression (30))
Product of the above average value and a prescribed coefficient close to 1
Height of the first contact area (corresponding to numerical expression (31))
Maximum value between the heights of the first and second contact areas (corresponding to numerical expression (32))
Product of the maximum value and a prescribed coefficient close to 1

As described above, whether the third case exists depends upon the definitions of the horizontal arrangement condition and the vertical arrangement condition. For example, when only one threshold is used relative to the absolute value |θ| of angle θ, the third case does not exist, and steps S308 through S309 are deleted in FIG. 8. However, depending upon the definitions of the horizontal arrangement condition and the vertical arrangement condition, the third case can exist as illustrated in FIG. 8.

In the third case, the correction management unit 15 determines whether to update the correction value ΔX and the correction value ΔY on the basis of the width and height of the second object area. Specifically, the correction management unit 15 updates the correction value ΔX and the correction value ΔY when the following two conditions are both met.
That the width of the second contact area is equal to or smaller than the third threshold that is determined in accordance with the width(s) of one or both of the first and second contact areas
That the height of the second contact area is equal to or smaller than the fourth threshold that is determined in accordance with the height(s) of one or both of the first and second contact areas

When by contrast at least one of the following two conditions is met, the correction management unit 15 updates neither the correction value ΔX nor correction value ΔY.
That the width of the second contact area is greater than the third threshold
That the height of the second object area is greater than the fourth threshold

Note that the third threshold may be for example any of the above values exemplified relative to the first threshold, or may also be other appropriate values. The fourth threshold may be for example any of the above values exemplified relative to the second threshold, or may also be other appropriate values.

Incidentally, each area may be expressed by a bounding box, or may also be expressed by a shape that is not rectangular. When a shape that is not rectangular is used, an appropriate collision determination algorithm may be used.

It is preferable that each of the horizontal arrangement condition and the vertical arrangement condition be defined on the basis of geometric relationships between the first object area, the second object area, the first contact area and the second contact area. Specific definitions of the horizontal arrangement condition and the vertical arrangement condition may be for example definitions in accordance with the shapes of areas.

For example, “whether the first object area, the second object area, the first contact area and the second contact area meet the horizontal arrangement condition” may be defined by the angle formed by the line connecting the following two points and the horizontal direction. Similarly, “whether the first object area, the second object area, the first contact area and the second contact area meet the vertical arrangement condition “may also be defined by the angle formed by the line connecting the following two lines and the horizontal direction”. However, in some embodiments, other definitions of the horizontal arrangement condition and the vertical arrangement condition may be used.
Point that represents the first overlapping area in which the first object area and the first contact area are overlapping (for example, first overlapping areas O1, O3, O5, etc. illustrated in FIG. 10)
Point that represents the second overlapping area in which the second object area and the second contact area are overlapping (for example, first overlapping areas O2, O4, O6, etc. illustrated in FIG. 10)

A point representing an area may be for example the centroid of the area. A specific example of an angle formed by the line connecting the above two lines and the horizontal direction is angle θ illustrated in FIG. 10. In the examples illustrated in FIG. 8 through FIG. 10, the horizontal arrangement condition and the vertical arrangement condition are defined by using two thresholds as described below.
When the absolute value |θ| of angle θ represented within the range of −90 degrees through 90 degrees is smaller than a fifth threshold (20 degrees for example), the horizontal arrangement condition is met.
When the absolute value |θ| of angle θ is greater than a sixth threshold, which is greater than the fifth threshold and smaller than 90 degrees (70 degrees for example), the vertical arrangement condition is met.
When the absolute value |θ| of angle θ is equal to or greater than the fifth threshold and equal to or smaller than the sixth threshold, neither the horizontal arrangement condition nor vertical arrangement condition is met.

Explanations will be given for the effects of the above various embodiments.

The user can manipulate the terminal device 10 through a gesture (i.e., an erroneous manipulation) on the touch screen 11. However, a mistaken touch can occur (i.e., erroneous manipulation) in for example the following cases.
Case where the touch screen 11 is small so that each GUI object is displayed in small size
Case where GUI objects are small originally regardless of the size of the touch screen 11

Whether the touch screen 11 and GUI objects are sufficiently large or small is determined on the basis of the size of an object that is used for touch manipulation (for example, the user's finger or a pen).

An erroneous manipulation is a manipulation that is not intended by the user. Accordingly, the occurrence of erroneous manipulations leads to degraded usability. Accordingly, it is preferable that erroneous manipulations be reduced.

In the above various embodiments, the horizontal correction information and the vertical correction information in the correction DB 14 are learned. Also, as time elapses, the horizontal correction information and the vertical correction information enter a state in which they are well adapted to the tendency of the user's touch manipulation. Accordingly, the above various embodiments can reduce erroneous manipulations.

Also, the above various embodiments can be applied to various pieces of application software. For example, in a piece of application software, only a window of a specific pattern in which some GUI objects are laid out sparsely may be used. However, in another piece of application software (for example a web browser), the size and layout of GUI objects may be arbitrary. The above various embodiments can be applied regardless of the size or layout of GUI objects.

For example, the following comparison example may be possible. An area that is larger than the area occupied by each GUI object by a margin may be defined as the effective area of a touch manipulation on the GUI object.

When a touch manipulation has been performed on an effective area, the application software conducts a process corresponding to the touch manipulation. In a specific piece of application software that uses only a window of a specific pattern in which some GUI objects are laid out sparsely, it is possible to avoid overlapping between effective areas.

In the present comparison example, it is possible to treat, as an erroneous manipulation, a case where a touch manipulation has been performed in a position that is close to an effective area and that is included in an ineffective area. Accordingly, in such a case, the correction information may be updated. In the above specific piece of application software, it is also possible to improve the usability by using above updating method based on an effective area.

The method in the comparison example described above does not work so effectively when it is applied to a piece of application software in which GUI objects can be laid out densely. This is because when GUI objects are laid out densely, the entire part or large part of the touch screen 11 is covered with an effective area (and thus there is no ineffective areas or ineffective areas are small). Accordingly, when GUI objects are laid out densely, there is a high possibility that correction information will not be updated well (i.e., that the usability will not improve).

However, it is in a window with GUI objects laid out densely that erroneous manipulations are likely to occur, and such a window is a window for which it is desirable that the usability be improved. Accordingly, even when GUI objects are laid out densely, it is desirable that the terminal device well learn the correction information.

According to the above various embodiments, the terminal device 10 can learn horizontal correction information and the vertical correction information in the correction DB 14 well even when GUI objects are laid out densely.

This is because a specific manipulation sequence including a cancellation manipulation (i.e., a manipulation sequence of “first touch manipulation, cancellation manipulation and second touch manipulation”) is detected as a trigger for determining whether to update the correction DB 14. A cancellation manipulation can be detected in any layout of GUI objects. In other words, in the above embodiments, the risk of failing to recognize the possibility of erroneous manipulations is low. This is in contrast to the high risk that “because GUI objects are laid out so densely that there is no ineffective areas or (ineffective area is small), and accordingly it is not possible to detect a trigger” in the above comparison example.

Meanwhile, there is also a possibility that a cancellation manipulation will be performed due to a cause that is not an erroneous manipulation. However, according to the above various embodiments, when the probability that “cancellation manipulation and second touch manipulation were performed due to a cause that is not an erroneous manipulation” is high, the correction DB 14 is not updated. Therefore, according to the above various embodiments, it is possible to avoid inappropriate updates (or excessive updates).

Specifically, an update of the correction DB 14 is avoided in the following cases. Therefore, according to the above various embodiments, it is possible to prevent noise that would be caused by inappropriate updates.
Case when first and second contact areas are far apart according to a prescribed criterion
Case when a cancellation manipulation was performed after a period of time longer than a prescribed period of time has elapsed since a first touch manipulation was performed
Case when a second manipulation was performed after a period of time longer than a prescribed period of time has elapsed since a cancellation manipulation was performed
Case when a second cancellation manipulation for cancelling a second touch manipulation was performed within a prescribed period of time after the second touch manipulation was performed
Case when a second object area is sufficiently large with respect to the size of the contact area in a prescribed direction in response to a second touch manipulation relative to a first touch manipulation (specifically, the X direction, the Y direction or both of them)

Incidentally, avoiding inappropriate updates as described above is effective in increasing the accuracy of the horizontal correction information and the vertical correction information. Further, avoiding inappropriate updates is effective also in reducing processing loads that would be caused by inappropriate updates (for example, processing loads of arithmetic operations conducted by the CPU 21, loads of memory accesses and/or disk accesses, etc.). In other words, the above various embodiments brings about effects that make it possible to learn highly accurate horizontal correction information and vertical correction information while avoiding unnecessarily high loads.

For example, in example E8 illustrated in FIG. 9, object areas G39 and G40 are arranged highly densely, whereas the probability that the user intending to touch object area G40 will touch contact area C39 is low. This is because the width of object area G40 is sufficiently great. In the above various embodiments, unnecessary updates (in other words, excessive and inappropriate updates) of the correction DB 14 are avoided on the basis of for example the above consideration.

Also, according to the above various embodiments, first and second object areas that respectively correspond to first and second touch manipulations are dynamically identified by the manipulation detection unit 16. Also, first and second contact areas are also areas identified dynamically in response to first and second touch manipulations and are not static areas. Accordingly, geometric relationships between a first contact area, a second contact area, a first object area and a second object area are not static but dynamic.

According to the above various embodiments, the correction management unit 15 determines whether to update only correction value ΔX, to update only correction value ΔY, to update both correction value ΔX and correction value ΔY or to update nether of them in accordance with the above dynamic geometric relationship. Accordingly, even when the size, shape, layout etc. of GUI objects are not statically fixed in advance, the above various embodiments can be applied preferably.

For example, as a comparison example, a method is also possible in which it is assumed that the size, shape, layout, etc. of GUI objects are fixed in advance. Specifically, a method is possible in which distances and sizes are determined by using a fixed threshold based on the size etc. of a GUI object, the size having been fixed in advance.

Compared with this comparison example, the above various embodiments are wider in applicability and more advantageous in flexibility. This is because, according to the above various embodiments, determination of distances or sizes uses the sizes of contact areas as a criterion instead of a prescribed fixed threshold based on the size etc. of a GUI object that has been determined statically in advance. According to the above various embodiments, even when the size, shape, layout, etc. of GUI objects are not known in advance, appropriate updates of correction information are realized. When, particularly, the size itself of a contact area is detected by the position detection unit 13 dynamically, the accuracy of correction value ΔX and correction value ΔY increases.

According to the above various embodiments, the correction management unit 15 takes the direction of a second touch manipulation relative to a first touch manipulation into consideration. Such a direction is the direction of an erroneous manipulation from a certain point of view. It is also possible to consider that such a direction reflects the intention of the user in a first touch manipulation. Accordingly, from a certain point of view, it is also possible to consider that the correction management unit 15 estimates the intention of the user in a first touch manipulation. On the basis of the estimation, the correction management unit determines “whether it is preferable to update only correction value ΔX, to update only correction value ΔY or to update both of them”.

Considering the directions of erroneous manipulations is effective in learning correction value ΔX and correction value ΔY highly accurately. In other words, considering the directions of erroneous manipulations is effective in avoiding inappropriate updates.

When for example the direction represented by angle θ illustrated in FIG. 8 is close to the X direction, the probability that the positional difference in the Y direction between first and second contact areas (for example, difference dY expressed by numerical expression (33) or (34)) is an accidental difference instead of a difference caused by an erroneous manipulation is high. Accordingly, when the direction represented by angle θ illustrated in FIG. 8 is close to the X direction, it is not so preferable that correction value ΔY be updated in accordance with accidental difference dY.

Accordingly, in the above various embodiments, the correction management unit 15 updates only correction value ΔX in step S305, and does not update correction value ΔY. In other words, the correction management unit 15 considers difference dX in the X direction, which represents a feature of the erroneous manipulation, while ignoring difference dY in the Y direction, which is accidental.

By contrast, in step S307, the correction management unit 15 considers difference dY in the Y direction, which represents a feature of the erroneous manipulation while ignoring difference dX in the X direction, which is accidental. Note that when angle θ represents a diagonal direction, which is close to neither the X direction nor Y direction, both difference dX and difference dY represent a feature of the erroneous manipulation. Accordingly, the correction management unit 15 considers both difference dX and difference dY in step S309.

Incidentally, the above various embodiments also have an advantage that the user is not interfered (i.e., the user is not frustrated).

For example, as a comparison example, a method is also possible in which when a cancellation manipulation has been performed after a first touch manipulation, a menu is displayed for the user. Specifically, the menu prompts the user to select one of at least one GUI object in the vicinity of a first object area. The menu may be displayed for example in an enlarged state.

However, in some cases, the user performs a cancellation manipulation due to a cause that is not an erroneous manipulation as in for example example E2 illustrated in FIG. 2. According to the above comparison example, even when the user has not performed an erroneous manipulation, a menu that is unnecessary for the user is displayed. In other words, the above comparison example frustrates the user. However, the above various embodiments do not interfere the user, and accordingly is excellent.

Also, as another comparison example, a method is also possible in which when a first contact area is overlapping two or more GUI objects at least partially, a portion in the vicinity of the first contact area is displayed in an enlarged state.

However, it is not that an erroneous manipulation always occurs when a first contact area is overlapping two or more GUI objects at least partially. Accordingly, the display in an enlarged state in this comparison example frustrates the user. Whereas the above various embodiments do not frustrate the user, and accordingly is excellent.

As described above, the above various embodiments bring about various excellent effects in improving the usability (in other words, manipulability). Improvement of usability leads to improvement of operation efficiency, and is beneficial.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing device comprising:
a touch screen;
a storage device; and
a processor that
detects an area, touched in a touch manipulation, on the touch screen;
reads, from the storage device, horizontal correction information and vertical correction information for correcting a position of the detected area in a horizontal direction and a vertical direction, respectively;
corrects the position of the detected area by using the horizontal correction information and the vertical correction information;
identifies an area occupied by a graphical user interface object that is a target of the touch manipulation on the touch screen, on the basis of the corrected position;
determines whether to update the horizontal correction information, the vertical correction information, both the horizontal correction information and the vertical correction information, or neither the horizontal correction information nor the vertical correction information, on the basis of a geometric relationship between a first object area, a second object area, a first contact area and a second contact area, the first and second object areas having been identified respectively in response to a first touch manipulation and a second touch manipulation and the first and second contact areas respectively having been detected and having had positions corrected in response to the first touch manipulation and the second touch manipulation, when the first touch manipulation, a cancellation manipulation for cancelling the first touch manipulation, and the second touch manipulation were performed sequentially; and
operates in accordance with the determination.

2. The information processing device according to claim 1, wherein
the processor
determines whether to update the horizontal correction information and whether to update the vertical correction information on the basis of a direction that is a direction of the second touch manipulation relative to the first touch manipulation and that is a direction determined on the basis of the geometric relationship and on the basis of a size of the second object area when the first contact area and the second contact area are close to each other according to a prescribed criterion; and
updates neither the horizontal correction information nor the vertical correction information when the first contact area and the second contact area are far apart according to the prescribed criterion.

3. The information processing device according to claim 2, wherein
the processor
determines whether to update the horizontal correction information on the basis of a width of the second object area in the horizontal direction and does not update the vertical correction information in a first case where the first contact area and the second contact area are close to each other according to the prescribed criterion, and the first object area, the second object area, the first contact area, and the second contact area meet a horizontal arrangement condition for determining whether the second touch manipulation was performed in a direction close to the horizontal direction relative to the first touch manipulation; and
determines whether to update the vertical correction information on the basis of a height of the second object area in the vertical direction and does not update the horizontal correction information in a second case where the first contact area and the second contact area are close to each other according to the prescribed criterion, and the first object area, the second object area, the first contact area and the second contact area meet a vertical arrangement condition for determining whether the second touch manipulation was performed in a direction close to the vertical direction relative to the first touch manipulation.

4. The information processing device according to claim 3, wherein
in the first case, the processor
updates the horizontal correction information when the width of the second object area is equal to or smaller than a first threshold that is determined in accordance with a width, in the horizontal direction, of one or both of the first and second contact areas; and
does not update the horizontal correction information when the width of the second object area is greater than the first threshold, and
in the second case, the processor
updates the vertical correction information when the height of the second object area is equal to or smaller than a second threshold that is determined in accordance with a height, in the vertical direction, of one or both of the first and second contact areas; and
does not update the vertical correction information when the height of the second object area is greater than the second threshold.

5. The information processing device according to claim 3, wherein
the processor
determines whether to update the horizontal correction information and the vertical correction information on the basis of the width and the height of the second object area in a third case where the first contact area and the second contact area are close to each other according to the prescribed criterion, and the first object area, the second object area, the first contact area and the second contact area meet neither the horizontal arrangement condition nor the vertical arrangement condition.

6. The information processing device according to claim 5, wherein
in the third case, the processor
updates both the horizontal correction information and the vertical correction information when the width of the second object area is equal to or smaller than a third threshold that is determined in accordance with a width, in the horizontal direction, of one or both of the first and second contact areas and the height of the second object area is equal to or smaller than a fourth threshold that is determined in accordance with a height, in the vertical direction, of one or both of the first and second contact areas; and
updates neither the horizontal correction information nor the vertical correction information when the width of the second object area is greater than the third threshold or the height of the second object area is greater than the fourth threshold.

7. The information processing device according to claim 3, wherein
whether the first object area, the second object area, the first contact area and the second contact area meet the horizontal arrangement condition is determined by an angle formed by the horizontal direction and a line connecting a point representing a first overlapping area in which the first object area and the first contact area are overlapping and a point representing a second overlapping area in which the second object area and the second contact area are overlapping; and
whether the first object area, the second object area, the first contact area and the second contact area meet the vertical arrangement condition is determined by the angle.

8. The information processing device according to claim 2, wherein
the prescribed criterion is:
a criterion that at least part of the first contact area and at least part of the second contact area overlap;
a criterion that a distance between a point representing the first contact area and a point representing the second contact area is equal to or shorter than a threshold based on a size of one or both of the first and second contact areas; or
a criterion that at least part of a union of the first contact area and a first margin area set around the first contact area and at least part of a union of the second contact area and a second margin area set around the second contact area overlap.

9. The information processing device according to claim 1, wherein
the processor
determines how much to update the horizontal correction information on the basis of a position of the second contact area in the horizontal direction; and
determines how much to update the vertical correction information on the basis of a position of the second contact area in the vertical direction.

10. The information processing device according to claim 9, wherein
the processor
calculates a new horizontal correction value by using a current horizontal correction value represented by the horizontal correction information and a first difference between a position of the second contact area in the horizontal direction and a position of the first contact area in the horizontal direction when the horizontal correction information is to be updated; and
calculates a new vertical correction value by using a current vertical correction value represented by the vertical correction information and a second difference between a position of the second contact area in the vertical direction and a position of the first contact area in the vertical direction when the vertical correction information is to be updated.

11. The information processing device according to claim 10, wherein
the processor
calculates the new horizontal correction value by adding a product of the first difference and a first coefficient to the current horizontal correction value; and
calculates the new vertical correction value by adding a product of the second difference and a second coefficient to the current vertical correction value, wherein
the first coefficient is a constant, a value dependent upon the first difference or a value dependent upon the number of times that the horizontal correction information that is an update target has been updated up to the present, and
the second coefficient is a constant, a value dependent upon the second difference, or a value dependent upon the number of times that the vertical correction information that is an update target has been updated up to the present.

12. The information processing device according to claim 1, wherein
the storage device stores the horizontal correction information and the vertical correction information so that the horizontal correction information and the vertical correction information respectively correspond to a plurality of determined correction conditions; and
the processor
corrects the position of the detected area by using the horizontal correction information and the vertical correction information that correspond to a correction condition that is met from among the plurality of correction conditions;
updates the horizontal correction information corresponding to a specific correction condition that was met at the time of the first touch manipulation from among the plurality of correction conditions when the horizontal correction information is to be updated; and
updates the vertical correction information corresponding to the specific correction condition when the vertical correction information is to be updated.

13. The information processing device according to claim 12, wherein
the plurality of correction conditions are:
a plurality of positional conditions related to what portion was touched on the touch screen;
a plurality of orientational conditions related to orientation of the touch screen;
a plurality of application conditions related to what piece of application software the touch manipulation was performed on;
a plurality of object conditions related to a property of a graphical user interface object occupying an area that is at least partially overlapping the area detected by the process of detecting performed by the processor; or
a plurality of conditions expressed by a combination of at least two types of the plurality of positional conditions, the plurality of orientational conditions, the plurality of application conditions and the plurality of object conditions.

14. An input control method performed by an information processing device that includes a touch screen, a storage device and a processor, the input control method comprising:
detecting an area, touched in a touch manipulation, on the touch screen, by the processor;
reading, from the storage device, horizontal correction information and vertical correction information for correcting a position of the detected area in a horizontal direction and a vertical direction, respectively, by the processor;
correcting the position of the detected area by using the horizontal correction information and the vertical correction information, by the processor;
identifying an area occupied by a graphical user interface object that is a target of the touch manipulation on the touch screen, on the basis of the corrected position, by the processor;
determining whether to update the horizontal correction information, the vertical correction information, both the horizontal correction information and the vertical correction information, or neither the horizontal correction information nor the vertical correction information, on the basis of a geometric relationship between a first object area, a second object area, a first contact area and a second contact area, the first and second object areas having been identified respectively in response to a first touch manipulation and a second touch manipulation and the first and second contact areas respectively having been detected and having had positions corrected in response to the first touch manipulation and the second touch manipulation, when the first touch manipulation, a cancellation manipulation for cancelling the first touch manipulation, and the second touch manipulation were performed sequentially, by the processor; and
operating in accordance with the determination, by the processor.

15. A computer-readable recording medium having stored therein a program for causing a computer that includes a touch screen to execute a process comprising:
detecting an area, touched in a touch manipulation, on the touch screen;
reading, from the storage device, horizontal correction information and vertical correction information for correcting a position of the detected area in a horizontal direction and a vertical direction, respectively;
correcting the position of the detected area by using the horizontal correction information and the vertical correction information;
identifying an area occupied by a graphical user interface object that is a target of the touch manipulation on the touch screen, on the basis of the corrected position;
determining whether to update the horizontal correction information, the vertical correction information, both the horizontal correction information and the vertical correction information, or neither the horizontal correction information nor the vertical correction information, on the basis of a geometric relationship between a first object area, a second object area, a first contact area and a second contact area, the first and second object areas having been identified respectively in response to a first touch manipulation and a second touch manipulation and the first and second contact areas respectively having been detected and having had positions corrected in response to the first touch manipulation and the second touch manipulation, when the first touch manipulation, a cancellation manipulation for cancelling the first touch manipulation, and the second touch manipulation were performed sequentially; and
operating in accordance with the determination.
